(19) United States
(12) Patent Application Publication
(10) Pub. No.: US 2025/0328893 A1
(43) Pub. Date: Oct. 23, 2025

(54) ARTIFICIAL INTELLIGENCE DRIVEN VIRTUAL CARD PAYMENTS

(71) Applicant: Capital One Services, LLC, McLean, VA (US)

(72) Inventors: Jackson Macomber, McLean, VA (US); Madeline Riese, McLean, VA (US); Jeffrey Wieker, McLean, VA (US); Austin Fuglestad, McLean, VA (US); Charlie Size, McLean, VA (US)

(73) Assignee: Capital One Services, LLC, McLean, VA (US)

(21) Appl. No.: 19/183,213

(22) Filed: Apr. 18, 2025

Related U.S. Application Data
(60) Provisional application No. 63/636,316, filed on Apr. 19, 2024.

(51) Int. Cl. G06Q 20/34; G06F 3/04842; G06Q 30/0251; G06Q 30/0601

(52) U.S. Cl. CPC G06Q 20/351; G06F 3/04842; G06Q 30/0257; G06Q 30/0641

(57) ABSTRACT

Systems and methods facilitate automated e-commerce checkouts using artificial intelligence (AI). An AI component, implemented via a processor and memory, processes content originating from a merchant server and presented on a client device, where the content identifies a purchasable item. The AI component also processes user data reflecting historical behavior or preferences. Based on analyzing the content and user data, the AI component determines if a predefined trigger condition for offering automated checkout is met. If the condition is met, a selectable interface element representing an automated checkout option is presented via the client device. Upon receiving user selection of the element, the AI component performs an operation.

### CROSS-REFERENCE TO RELATED APPLICATION

This application claims the priority OF U.S. Provisional Patent Application No. 63/636,316, filed on Apr. 19, 2024, the contents of which are incorporated herein by reference in their entirety.

### BACKGROUND

Conventional solutions for automated checkouts require manual configuration to accommodate disparate platforms. Furthermore, these conventional automated checkout solutions present unnecessary risk, as these solutions can be initiated at any time by malicious actors.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an aspect of the subject matter in accordance with one embodiment.

FIG. 2A illustrates an aspect of the subject matter in accordance with one embodiment.

FIG. 2B illustrates an aspect of the subject matter in accordance with one embodiment.

FIG. 2C illustrates an aspect of the subject matter in accordance with one embodiment.

FIG. 3A illustrates an aspect of the subject matter in accordance with one embodiment.

FIG. 3B illustrates an aspect of the subject matter in accordance with one embodiment.

FIG. 3C illustrates an aspect of the subject matter in accordance with one embodiment.

FIG. 3D illustrates an aspect of the subject matter in accordance with one embodiment.

FIG. 4A illustrates an aspect of the subject matter in accordance with one embodiment.

FIG. 4B illustrates an aspect of the subject matter in accordance with one embodiment.

FIG. 4C illustrates an aspect of the subject matter in accordance with one embodiment.

FIG. 5 illustrates a flow 500 in accordance with one embodiment.

FIG. 6 illustrates a flow 600 in accordance with one embodiment.

FIG. 7 illustrates a system 700 in accordance with one embodiment.

FIG. 8 illustrates an apparatus 800 in accordance with one embodiment.

FIG. 9 illustrates an artificial intelligence architecture 900 in accordance with one embodiment.

FIG. 10 illustrates an artificial neural network 1000 in accordance with one embodiment.

FIG. 11 illustrates a computing architecture 1100 in accordance with one embodiment.

### DETAILED DESCRIPTION

Embodiments disclosed herein provide techniques for automated checkout process using artificial intelligence. Often, financial institutions provide virtual card services such that a one-time use virtual card (also referred to as a virtual card number, virtual account number, virtual payment instrument, etc.) can be generated to process payments instead of the sensitive payment information (e.g., account number, expiration date, card verification value (CVV)) of a payment card (e.g., debit card, credit card, gift card, etc.). However, conventional solutions for using virtual card numbers are largely static and are not portable to multiple platforms. For example, different merchants may require different and/or disparate solutions for accepting payments using virtual card numbers. Furthermore, automated checkout processes are conventionally tailored to a specific merchant, such that different merchants require different and/or disparate solutions for automated checkouts.

Advantageously, embodiments disclosed herein provide artificial intelligence (AI) and machine learning (ML) (AI/ML) techniques for automated checkout processes using virtual card numbers. Some embodiments are particularly directed to using AI/ML techniques to detect triggers to initiate automated checkout processes. The triggers may include any trigger involving a resource, such as viewing a product page, accessing a shopping cart page, accessing a checkout page, serving an advertisement, customer-specific triggers (e.g., customer preferences, purchase histories, browsing histories, etc.). Once a trigger is detected, embodiments disclosed herein may inject an object to facilitate the automated checkout.

For example, embodiments disclosed herein may inject a button on a product page. When a customer selects the button, embodiments disclosed herein may automatically complete a purchase of the product. For example, to automatically complete the purchase, embodiments disclosed herein may generate a virtual card number (VCN), expiration date, and CVV for the purchase. The virtual account number may include one or more restrictions (e.g., a merchant restriction (e.g., restricted to use at a specific merchant), time duration restriction (e.g., restricting use of the virtual account to a predetermined amount of time, restricting use through a predetermined date, etc.), monetary amount restrictions, etc. The VCN (and other relevant data such as customer name, address, merchant information, purchase information, etc.) may then be provided to the merchant to process the transaction. The purchase may then be completed using the VCN. Embodiments are not limited in these contexts.

The AI/ML techniques overcome conventional techniques by learning and identifying triggers to drive an artificially intelligent interface to automate purchases. Furthermore, unlike 1-click checkout applications, password storage applications, or other conventional solutions, embodiments disclosed herein operate regardless of the merchant, a particular website, or VCN. For example, by abstracting the services away from a particular website (and/or merchant) to run on top the website, embodiments disclosed herein can be used by any computing service. Furthermore, although exemplary embodiments are described in connection with a particular AI or ML system, the principles described herein can also be applied to other types of machine learning systems as well. Embodiments are not limited in this context.

Reference is now made to the drawings, wherein like reference numerals are used to refer to like elements throughout. In the following description, for purposes of explanation, numerous specific details are set forth in order to provide a thorough understanding thereof. However, the novel embodiments can be practiced without these specific details. In other instances, well known structures and devices are shown in block diagram form in order to facilitate a description thereof. The intention is to cover all modifications, equivalents, and alternatives consistent with the claimed subject matter.

In the Figures and the accompanying description, the designations “a” and “b” and “c” (and similar designators) are intended to be variables representing any positive integer. Thus, for example, if an implementation sets a value for a=5, then a complete set of components 121 illustrated as components 121-1 through 121-a may include components 121-1, 121-2, 121-3, 121-4, and 121-5. The embodiments are not limited in this context.

Operations for the disclosed embodiments may be further described with reference to the following figures. Some of the figures may include a logic flow. Although such figures presented herein may include a particular logic flow, it can be appreciated that the logic flow merely provides an example of how the general functionality as described herein can be implemented. Further, a given logic flow does not necessarily have to be executed in the order presented unless otherwise indicated. Moreover, not all operations illustrated in a logic flow may be required in some embodiments. In addition, a logic flow may be implemented by a hardware element, a software element executed by a processor, or any combination thereof. The embodiments are not limited in this context.

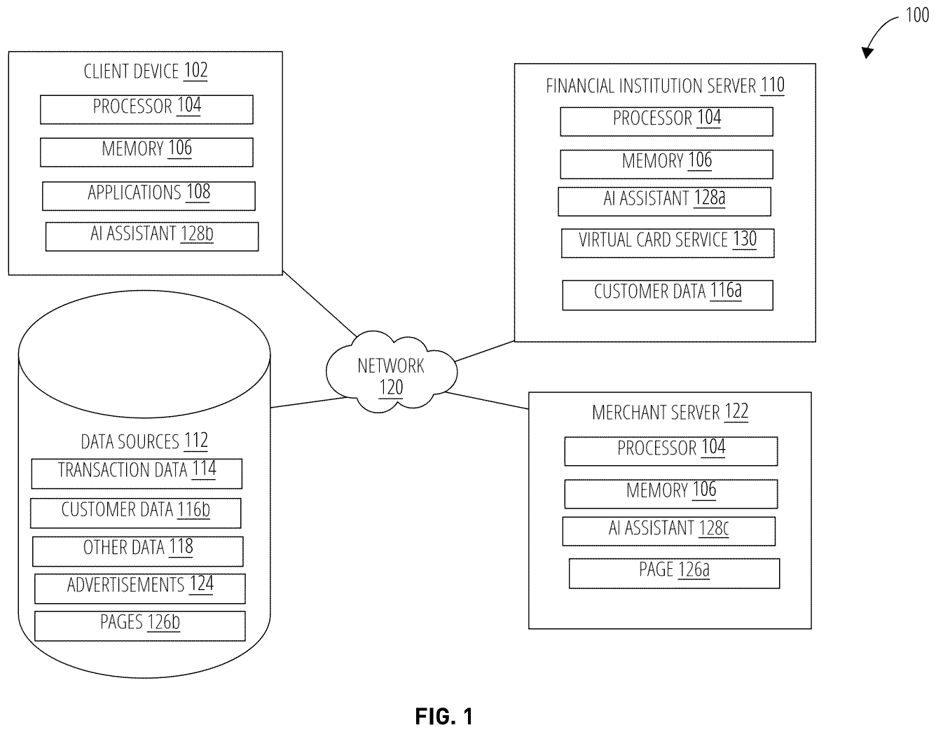

FIG. 1 illustrates a system 100. The system 100 comprises an exemplary electronic system suitable for implementing various AI/ML techniques as described herein.

As shown, the system 100 comprises one or more client devices 102, one or more financial institution servers 110, one or more data sources 112, and one or more merchant servers 122 communicably coupled via a communications network 120. The client devices 102, financial institution servers 110, data sources 112, and merchant servers 122 are representative of any type of computing device. For example, the client devices 102 may include, but not limited to computers, mobile devices, smart phones, wearable devices, laptops, virtualized device instances, game consoles, and the like. The financial institution servers 110, data sources 112, and merchant servers 122 may be, but are not limited to, servers, virtualized server instances, cloud computing systems, compute clusters, and the like. The client devices 102, financial institution servers 110, and merchant servers 122 include a respective processor 104 and a respective memory 106. The data sources 112 similarly include a processor 104 and a memory 106 (not pictured for clarity). In some embodiments, the financial institution server 110 and/or the merchant server 122 store data (or subsets thereof) stored in the data sources 112. The financial institution servers 110 may be associated with one or more financial institutions. The components of the merchant servers 122, financial institution servers 110, and/or data sources 112 may be included in one system or may be spread across multiple systems.

As shown, the client devices 102 include one or more applications 108. The applications 108 may be any number and type of application, such as web browsers, web browser extension, application store applications, shopping applications, social media applications, and the like. Using the application 108, the client device 102 may access resources provided by the financial institution server 110, data sources 112, and/or merchant server 122. For example, a web browser application 108 may be used to access one or more web pages 126a hosted by the merchant server 122. As another example, a dedicated application 108 provided by a merchant associated with merchant server 122 may be used to access pages 126a of the application 108 provided by the merchant server 122. The pages 126a-126b are representative of any type of resource accessible by the applications 108, such as web pages, web services, application pages, application services, and the like.

As shown, the merchant server 122 includes one or more instances of an AI assistant 128a, the client device 102 includes one or more instances of AI assistant 128b, and merchant server 122 includes one or more instances of AI assistant 128c. The instances of AI assistants 128a-128c (also referred to as AI components) may be the same or different instances of AI assistants. For example, AI assistants 128b and 128c may be copies of AI assistant 128a. As another example, respective instances of AI assistant 128a-128c may be trained for each of a plurality of customers and/or subsets of the plurality of customers. Therefore, for example, AI assistant 128b on a first client device 102 may be associated with a first customer of a plurality of customers while AI assistant 128b on a second client device 102 may be associated with a second customer of the plurality of customers. In some embodiments, the AI assistants 128a-128c are components of other entities, such as the pages 126a-126b, a web server, the applications 108, etc. For example, in some embodiments, the AI assistant 128b is implemented in a browser extension of a web browser. In some embodiments, the AI assistant 128b is implemented in the web browser. Embodiments are not limited in these contexts.

The AI assistants 128a-128c are representative of any type of artificial intelligence framework, such as a neural network, machine learning model, large language model, a classifier, and the like. Moreover, the AI assistants 128a-128c including the neural networks, potentially involving deep learning architectures like Convolutional Neural Networks (CNNs) for image tasks, Recurrent Neural Networks (RNNs) or Long Short-Term Memory units (LSTMs) for sequential data, or versatile Transformers, all designed to learn complex patterns from the data. Alternatively, they might employ techniques from the broader category of machine learning models, which includes neural networks but also other algorithms such as Support Vector Machines (SVMs), Decision Trees, Random Forests, or Gradient Boosting Machines, all trained to make predictions or decisions. Another possibility is the use of large language models (LLMs), sophisticated systems typically based on Transformer architectures (like GPT, BERT, Gemini, or Llama) trained on vast datasets for understanding, generating, or interacting via natural language. Furthermore, the AI assistants 128a-128c might function specifically as classifiers, whose purpose is to assign inputs to predefined categories, a task achievable using various underlying models like neural networks or SVMs. Other AI techniques such as rule-based expert systems, reinforcement learning agents that learn through interaction, unsupervised clustering algorithms for grouping data, or even hybrid approaches combining multiple methods may also be utilized. For the sake of clarity, embodiments may be discussed with reference to one of the AI assistants 128a-128c128a. However, embodiments are equally applicable to all instances of the AI assistant 128a-128c, and the recitation of any one of the AI assistants 128a-128c should not be considered limiting of the disclosure.

The AI assistants 128a-128c may be trained at least in part on data received from the data sources 112 and data describing the merchant servers 122 (e.g., configurations, locations of pages 126a, configurations of the pages 126a, attributes of the pages 126a, form field configurations, purchase flows, etc.). The AI assistants 128a-128c may be retrained at periodic timing intervals, based on requests, or for any reason. As shown, the data sources 112 include transaction data 114 (e.g., data describing transactions associated with one or more entities (e.g., transactions between one or more users and one or more merchants, etc.), customer data 116a-116b (e.g., account databases, customer profiles, or any other data describing a user), other data 118 (e.g., social media data, browsing data, loyalty program data, personal assistant data, merchant risk data, etc.), advertisements 124 (e.g., one or more advertisements and associated metadata), and the pages 126b (which may include the pages 126a provided by a plurality of merchants via merchant servers 122).

Other examples of data from the data sources 112 include, but are not limited to one or more of: (i) customer data (e.g., name, date of birth, address, preferences clothing sizes, transaction histories, payment histories, fraud histories, past purchases made using virtual card numbers, past purchases automated by the AI assistants 128a-128c, types of purchases, etc.), (ii) customer transaction data describing locations customers shop, items the customers purchase, shipping address history, payment methods for transactions, item costs, purchase amounts, fraud committed at merchants, etc., (iii) data describing devices such as client devices 102 that are used to make purchases, (iv) Social media streaming data (e.g., ads favorited by a user, products favorited by a user, social network information, etc.), (v) merchant shopping customer browsing data-data describing purchases made with a merchant, including via the merchant servers 122, data describing customer browsing history of resources (e.g., pages 126a) on the merchant servers 122, etc., (vi) customer browser data-a customer's web log, application logs, browsing history, etc., (vii) browser extension data-any shopping extension/payment method extension (gaming, shopping, autofill extensions), (viii) profile data for other users (e.g., when making a purchase for someone else), (ix) loyalty program data-rewards data, credit card data, merchant account data, travel data, hotel data, etc., (x) dialogue/personal assistant data-data from verbal discussions that could indicate purchasing need, such as dialogue with a smart speaker, a virtual assistant, chatbot, etc., (xi) affiliate marketing, and (xii) merchant risk data-how risky is the merchant and/or the merchant's website (e.g., as assessed by a central authority, by the financial institution server 110, etc.). Embodiments are not limited in these contexts. The data stored in the data sources 112 may be continuously updated (e.g., by the AI assistants 128a-128c, applications 108, client device 102, merchant servers 122, financial institution servers 110, or other systems).

The AI assistants 128a-128c may be trained to perform a variety of functions. For example, the AI assistants 128a-128c may be trained to identify triggers to initiate an automated checkout using a virtual card number (VCN) generated by the virtual card service 130. The VCN may be a series of numbers and/or alphanumeric characters that is different than the account number of a payment card associated with the customer. Moreover, A virtual card number is a digitally generated, virtual representation of a physical credit card number. It is a unique string of digits, often 16 digits long, that mimics the format of a real credit card number but is not tied to a specific physical card.

The triggers may be any type of trigger, such as viewing one of the pages 126a-126b (e.g., viewing a product page, viewing a checkout page, etc.), viewing one or more of the advertisements 124, accessing an application 108, identifying impulse shopping habits, identifying frequent purchases, and the like. In the context of digital shopping and e-commerce, triggers refer to specific actions or events that prompt the application of a virtual card number or another action. These triggers can be categorized into various types, including: (i) Page views: Specific pages on the website, such as product pages (e.g., pages 126a-126b), checkout pages, or category pages, may serve as triggers. (ii) Advertisements: Viewers of certain advertisements, such as banner ads or product promotions, may be prompted to use a virtual card number. (iii) Application access: Accessing specific applications or services offered by the merchant, such as subscription-based services or premium content. (iv) Impulse shopping habits: Identifying patterns of impulse purchases or browsing behavior may lead to preventing excessive spending. (v) Frequent purchases: Frequent customers may be prompted to use virtual card numbers to enhance security and prevent unauthorized transactions. (vi). Browser behavior: Other triggers may include browser behavior, such as time of day, day of the week, or device type, to name a few. These triggers enable merchants to implement dynamic payment options, such as virtual card numbers, to enhance customer experience, prevent unauthorized transactions, and meet regulatory requirements for secure payment processing.

As another example, the AI assistants 128a-128c may be trained to identify timing triggers (e.g., 3 weeks since the most recent purchase, where the transaction data 114 indicates the customer purchases the same item every 3 weeks). As another example, the AI assistants 128a-128c may be trained on decision complexity, e.g., to identify price drops as triggers, identifying new versions of products previously purchased as triggers, identifying products that have not been purchased as triggers, etc.

Similarly, the AI assistants 128a-128c may be trained to identify when not to initiate an automated purchase. For example, the AI assistants 128a-128c may be trained to determine to not automate a purchase when the customer's travel information (e.g., from the data sources 112 and/or location data from the client device 102) indicates the customer will be traveling away from home for 2 weeks, and therefore does not need to order milk. As another example, the AI assistants 128a-128c may be trained to avoid making a recurring purchase because the price recently increased. Furthermore, the AI assistants 128a-128c are trained to analyze code or other software (e.g., pages 126a-126b, applications 108, advertisements 124, etc.) to identify triggers. The AI assistants 128a-128c are further trained to inject code or other graphical user interface (GUI) elements selectable by a user to initiate the automated checkout process. Embodiments are not limited in these contexts.

The AI assistants 128a-128c may generally identify a trigger based on the training and data received from the client device 102, merchant server 122, financial institution server 110, and/or data sources 112. When a trigger is detected, the AI assistants 128a-128c may present an option to initiate an automated checkout to complete a purchase. For example, the AI assistant 128b within a web browser application 108 may inject or otherwise include HTML or other code into a page 126a to display a selectable element (e.g., a button, popup, link, etc.) to initiate the automated checkout process. Further, the AI assistants 128a-128c integrated within a web browser application possess the capability to modify the user interface of a displayed webpage dynamically. Specifically, when a user navigates to a relevant page, such as a shopping cart or product detail page, the AI assistant 128 can inject or otherwise embed snippets of code, like HTML, CSS, or JavaScript, directly into the page's existing structure. This injected code is designed to render a new, interactive element that wasn't originally part of the website's design. This element could take various forms, such as a clearly labeled button (“Auto-Checkout”), a small pop-up window offering the service, a clickable link, or even a distinct icon. The primary purpose of this dynamically added element is to serve as a user-facing trigger; upon being selected (e.g., clicked) by the user, it initiates an automated checkout process managed by the AI assistant 128, streamlining the steps required to complete a purchase.

Examples of such pages 126a include product pages, checkout pages, and the like. For example, the AI assistant 128b on client device 102 may analyze a page 126a displayed in an application 108 on the client device 102, and determine the page 126a is a product page for a product the user previously purchased (or expressed interest in). As another example, the AI assistant 128b on client device 102 may determine the page 126a is a checkout page. Embodiments are not limited in these contexts. In some embodiments, e.g., where the AI assistant 128b is implemented as a browser extension, the browser extension may provide a selectable element to initiate the automated checkout.

As another example, the AI assistants 128a-128c may cause a notification to be presented on the client device via an operating system (not pictured) of the client device 102. When the notification is selected, the automated checkout process is initiated. As another example, the AI assistants 128a-128c may inject, overlay, or otherwise present the selectable element on and/or adjacent to one of the advertisements 124 displayed on the client device 102. For example, when accessing a web page 126a, an advertisement 124 may be displayed within the page 126a in a browser application 108 of the client device 102. As other examples, the advertisement 124 may be on social media sites, search engines, etc. The AI assistant 128b may identify the advertisement 124 and determine to present the automated checkout option. In some embodiments, the AI assistant 128b may identify the advertisement based on metadata of the advertisement, a link where the advertisement is directed to (and/or served from), analyzing the advertisement content (e.g., using a reverse image search, object identification in an image of the advertisements, etc.). Embodiments are not limited in these contexts.

As another example, the AI assistants 128a-128c may be trained to identify the specification of a predetermined account number in a payment field of a payment form in pages 126a. For example, a predetermined account number (e.g., of a payment card) may be associated with creating VCNs. The AI assistant 128b on the client device 102 may identify the predetermined account number in a form field as a trigger. The AI assistant 128b may present a selectable option to complete the automated checkout. Once selected by the user, the AI assistant 128b may request a VCN from the virtual card service 130 (which may include a virtual account number, expiration date, and CVV). The AI assistant 128b may receive the VCN from the virtual card service 130. The AI assistant 128b may further access profile data of the user from the customer data 116a (e.g., names, addresses, email address, phone number, etc.). The AI assistant 128b may fill in the form with the VCN and other required data, and submit the form to complete the purchase. Doing so improves security by using a one-time use VCN that cannot be incorrectly entered by the user or accessed by a malicious entity. In embodiments, other payment information may be entered into other corresponding fields, e.g., account holder name, expiration, CVV, etc.

Because the AI assistants 128a-128c are trained based on the merchant servers 122, the resources provided by the merchant servers 122 (e.g., the pages 126a), the AI assistants 128a-128c are trained to automatically learn how to complete a purchase via the pages 126a and/or other resources of the merchant servers 122. For example, the AI assistants 128a-128c may be trained to learn purchase flows (e.g., a sequence of pages 126a to add items to carts and purchase the items) on each platform provided by the merchant servers 122. For example, the AI assistants 128a-128c may learn locations of the pages 126a in a purchase flow, parameters required for each page 126a in the purchase flow, form fields and associated metadata, and the like. Similarly, the AI assistants 128a-128c may learn how to complete purchases that do not require filling information into a variety of pages 126a, e.g., backend purchases where the AI assistants 128a-128c communicate directly with the merchant servers 122 without loading each individual page 126a of a purchase flow. Advantageously, doing so provides the AI assistants 128a-128c on top of any specific pages 126a and/or resources provided by the merchant servers 122, such that the AI assistants 128a-128c can operate on any platform.

In some embodiments, the AI assistants 128a-128c may access passwords (e.g., stored in a web browser, password vault, etc.) to log into a customer account with the merchant associated with merchant server 122 before completing the automated checkout. In some embodiments, the AI assistants 128a-128c may access payment information stored in the customer data 116a, the browser, password vault, etc., and complete the purchase using the stored payment information.

In some embodiments, the customer data 116a includes user preferences such as preferred colors, clothing sizes, shoe sizes, etc. In some embodiments, the AI assistants 128a-128c may determine these preferences based on transaction data 114 describing previous purchases made by the customer. Therefore, in some embodiments, the automated checkout process performed by the AI assistants 128a-128c includes the AI assistants 128a-128c providing input for customizable options, e.g., selecting the customer's favorite color shirt in the size specified in the customer's profile in the customer data 116a. In such embodiments, the AI assistants 128a-128c may add the product to the customer's shopping card, navigate to a checkout page, and complete the purchase on the checkout page using a VCN received from the virtual card service 130.

In some embodiments, to preserve security, the AI assistant 128b may complete a purchase without filling in form fields, e.g., by transmitting the VCN, customer information, purchase information (e.g., cart identifier, merchant identifier, etc.) to the merchant server 122 to process the transaction.

In some embodiments, the AI assistant 128b may further identify a trigger based on past purchases in the transaction data 114 and/or customer data 116a, preferences in the customer data 116a, etc. For example, the AI assistant 128b may identify a checkout page 126a in a browser application 108 on client device. The AI assistant 128b may access the transaction data 114 and/or customer data 116a to determine whether the customer has made previous purchases with the merchant associated with the web page, has previously purchased items in the customer's cart, whether the customer enabled automated checkout for the associated merchant, etc., before initiating the automated checkout. The AI assistant 128b may further consider attributes of the purchase, such as the prices of items in the cart, the number of items in the cart, predetermined purchase amount thresholds (e.g., a $100 purchase amount threshold, etc.), predetermined item amount thresholds (e.g., a $50 price threshold for a given item), when determining whether to initiate the automated checkout.

In some embodiments, the AI assistants 128a-128c may specify one or more controls (or restrictions) when requesting a VCN from the virtual card service 130. For example, the controls may include one or more of: a number of times the VCN may be used (e.g., one time for a single transaction, multiple times for recurring transactions), automatically locking the VCN, binding the VCN to a specific merchant such that the VCN can only be used to provide payment to the specific merchant, binding the VCN to a category of merchants (e.g., restaurants) such that the VCN can only be used to provide payment to that category of merchants, and/or a monetary limit. In some embodiments, one or more controls are received from the customer's profile in the customer data 116a.

In some embodiments, the AI assistants 128a-128c may further assist the user in identifying the alternates for products and/or services, e.g., by searching prices on other merchant servers 122 for the same and/or comparable products and/or services, identifying other merchants who may be offering greater rewards or cash back options, etc. In such embodiments, the AI assistants 128a-128c may present an advertisement, link, or other selectable element which takes the user to another page 126a that may have a lower price than the price displayed on the current page, or to another page where the merchant is offering more rewards and/or cash back than the merchant associated with the current page. In some embodiments, when an advertisement to another product and/or merchant is presented, the AI assistants 128a-128c may present an automated checkout option associated with the advertisement. As another example, if the user selects the link to another product/merchant and/or the advertisement for another product/merchant (but not the automated checkout option), the AI assistants 128a-128c may present the automated checkout option once the associated page 126a is loaded. Embodiments are not limited in these contexts.

In some embodiments, the various entities of the system 100 expose application programming interfaces (APIs) to provide the functionality disclosed herein. Specifically, in certain implementations or configurations of the system 100 the distinct components or modules that constitute the system rely on Application Programming Interfaces (APIs) as the primary mechanism for interaction and communication. Each of these entities, e.g., applications 108, AI assistants 128a-128c, virtual card service 130, pages 126, and other microservices to larger subsystems, essentially publish a defined set of rules and protocols—the API—that dictates how other parts of the system 100, or potentially external applications, can access its features or data. By exposing their capabilities through these standardized interfaces, the various entities enable the overall system to deliver the functionalities described throughout this disclosure. Embodiments are not limited in these contexts.

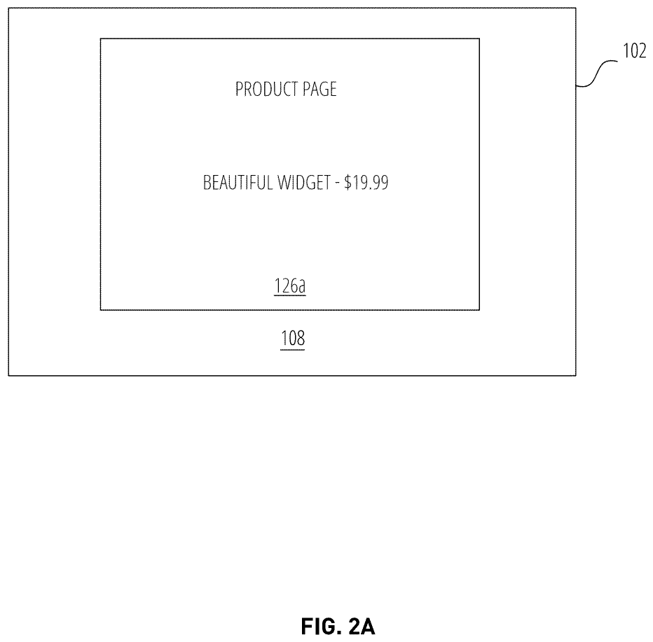

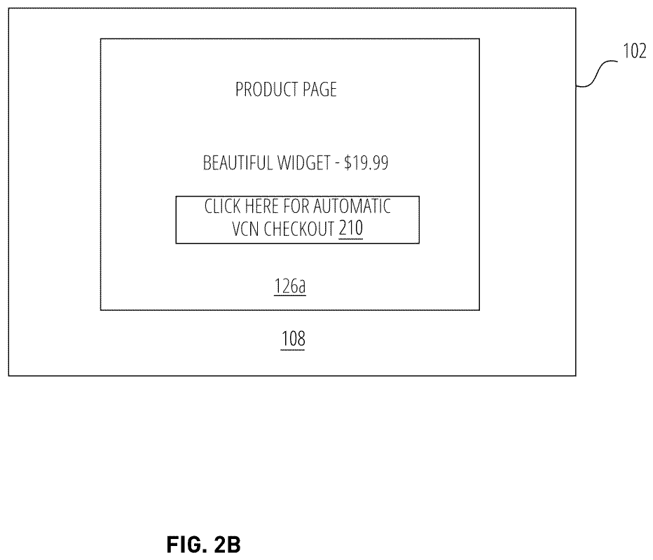

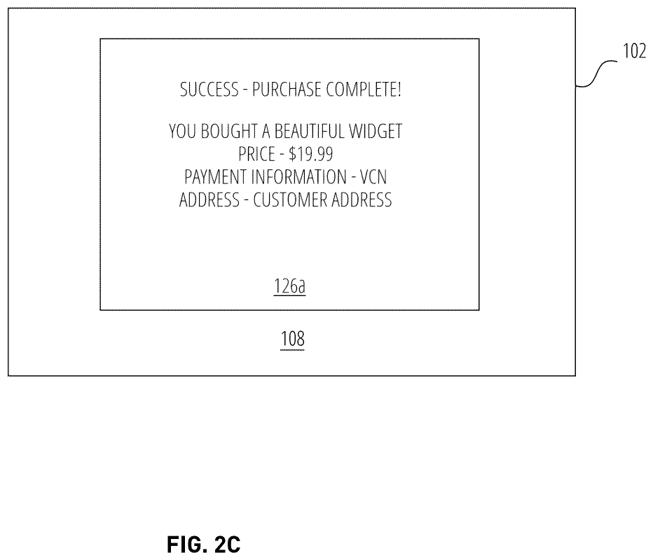

FIG. 2A illustrates an embodiment of an automated checkout on a client device 102, according to an embodiment. As shown, an application 108 such as a web browser has accessed a web page 126a, which is a product page for a widget. The AI assistant 128b may analyze the page 126a to determine the page is associated with a product. The AI assistant 128b may analyze data associated with the customer, e.g., the customer's transaction data 114, browsing data, customer data 116a, etc. The AI assistant 128b may determine, based on the analyses, a triggering event to present an automated checkout option.

Moreover, FIG. 2A provides a visual representation of how an automated checkout process might be initiated on a user's computing device, referred to as the client device 102, according to one specific embodiment of the system. The scenario depicted shows a common user activity: an application 108, explicitly identified here as a web browser, is actively rendering a specific web page, labeled 126a. This this example, the page 126a is as a product page, showcasing details for an item referred to generically as a “widget.” This identification is one operation performed by the integrated AI assistant 128b.

The AI assistant 128b actively processes the content and structure of this displayed page 126a. This analysis goes beyond simply displaying the page; the AI assistant 128b processes its elements, layout, and/or metadata to confirm its nature-specifically, determining that it is indeed a commercial page offering a product for sale. This might involve identifying common e-commerce elements like product titles, descriptions, pricing information, images, and “add to cart” buttons.

Concurrently or subsequently, the AI assistant 128b delves into various data sources associated with the specific customer using the device. The AI assistant 128b analyzes historical transaction data (114), which may reveal past purchasing habits and preferences. The AI assistant 128b may also examine the user's recent Browse data, looking for patterns that indicate purchase intent, such as visiting multiple pages for similar products or performing related searches. Furthermore, customer data (116a), potentially including profile information, saved preferences, or account status, is analyzed.

Based on the synthesis of these analyses—combining the understanding of the current webpage context (a product page) with insights derived from the user's historical and behavioral data—the AI assistant 128b makes an intelligent determination. The AI assistant 128b identifies if specific conditions or a confluence of factors constitutes a “triggering event.” This event signifies a calculated moment where offering an automated checkout option would be most relevant and potentially welcomed by the user. For example, a trigger might occur if the user has previously purchased similar items, has recently searched for this specific widget, and is currently lingering on the product page near the purchase button. Successfully identifying such a triggering event is the prerequisite for the AI assistant 128b to then proactively present the automated checkout option to the user, e.g., by injecting a button or link as described earlier.

FIG. 2B illustrates an embodiment where the AI assistant 128b presents an AI interface 210 on the client device 102. The AI interface 210 may be any selectable element, such as a graphic, button, link, popup, notification, etc. Once the user selects AI interface 210, the AI assistant 128b may automatically complete a purchase for the widget. For example, the AI assistant 128b may add the widget to the user's cart (using a selectable element of the web page 126a or by generating code to cause the widget to be added to the card). The AI assistant 128b may then optionally navigate to a predetermined checkout page 126a associated with the current merchant server 122. The AI assistant 128b may then request generation of a VCN from the virtual card service 130, where the request may include one or more controls for the VCN. The AI assistant 128b may further access other information required to complete the purchase, e.g., customer name, address, email, etc., from the customer's profile in the customer data 116a. Once received, the AI assistant 128b may provide the VCN and other data to the merchant server 122 to complete the transaction. In some embodiments, the AI assistant 128b uses interfaces (e.g., form fields such as fields 322-326, etc.) provided by the checkout page to complete the purchase. In some embodiments, the AI assistant 128b communicates directly with the merchant server 122 to complete the purchase without filling in the form fields, clicking submit, etc. The merchant server 122 may then process payment for the purchase using the VCN.

FIG. 2C shifts focus to the culmination of the automated checkout process, illustrating one possible way confirmation is presented to the user within the same Browse context, according to a specific embodiment. As depicted, the webpage 126a (or potentially an overlay or modified version thereof rendered by the applications 108), now displays a confirmation message signifying the successful completion of the automated purchase. This feedback is crucial for assuring the user that the transaction initiated via the AI assistant 128b was executed as intended.

In the particular example shown in FIG. 2C, the confirmation provides key details about the transaction. It explicitly indicates the final price paid for the item (the “widget” from the earlier context). Furthermore, this embodiment highlights a specific security feature by stating that a Virtual Card Number (VCN) was used to complete the payment. Mentioning the use of a VCN serves not only as confirmation but also subtly informs the user that their actual credit card details were shielded during the transaction, leveraging a temporary, potentially single-use number for enhanced security against exposure or misuse at the merchant site.

In some instances, other implementations might display different or additional confirmation details. For instance, confirmations in other embodiments could include an order or transaction ID, a summary of the item(s) purchased, estimated shipping information, or perhaps only the last four digits of the VCN used. The format could also vary, ranging from a simple success message to a more detailed digital receipt overlay. The core principle is providing clear feedback post-purchase, but the specific content and visual layout of this confirmation on page 126a (or its equivalent) can be adapted based on system design, user preferences, or the requirements of the transaction context.

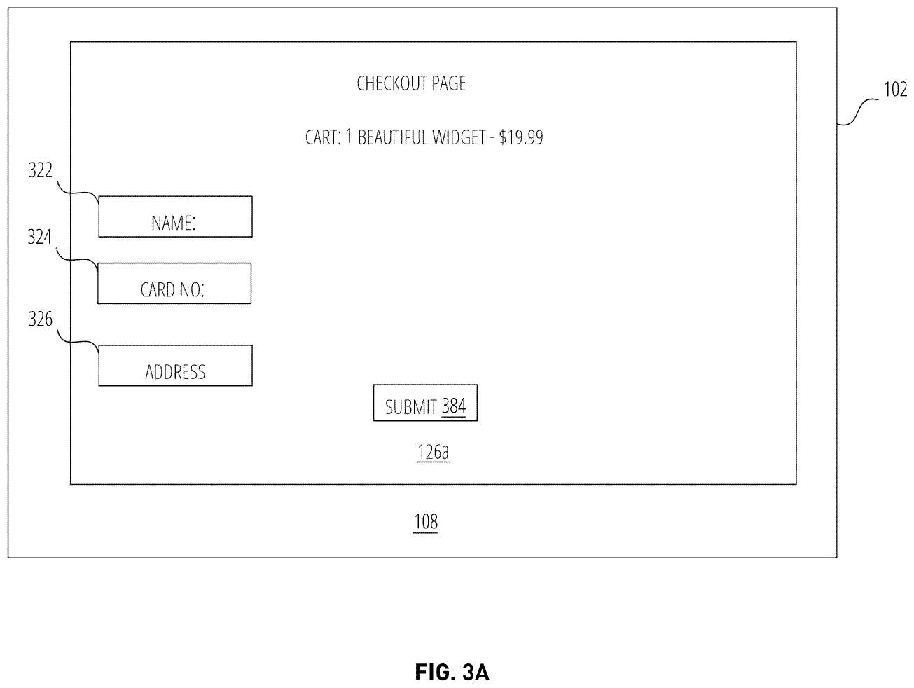

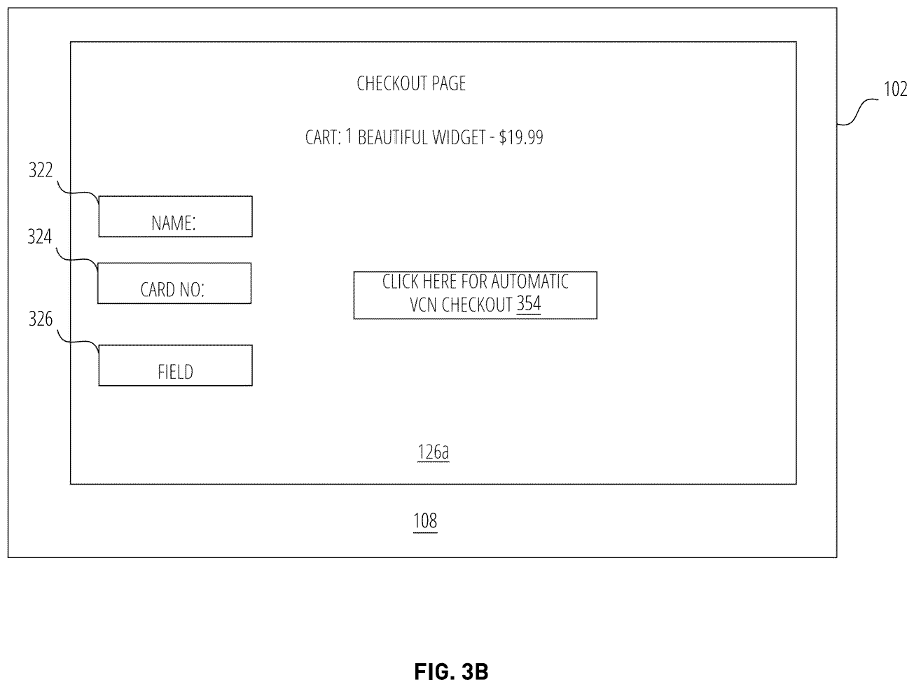

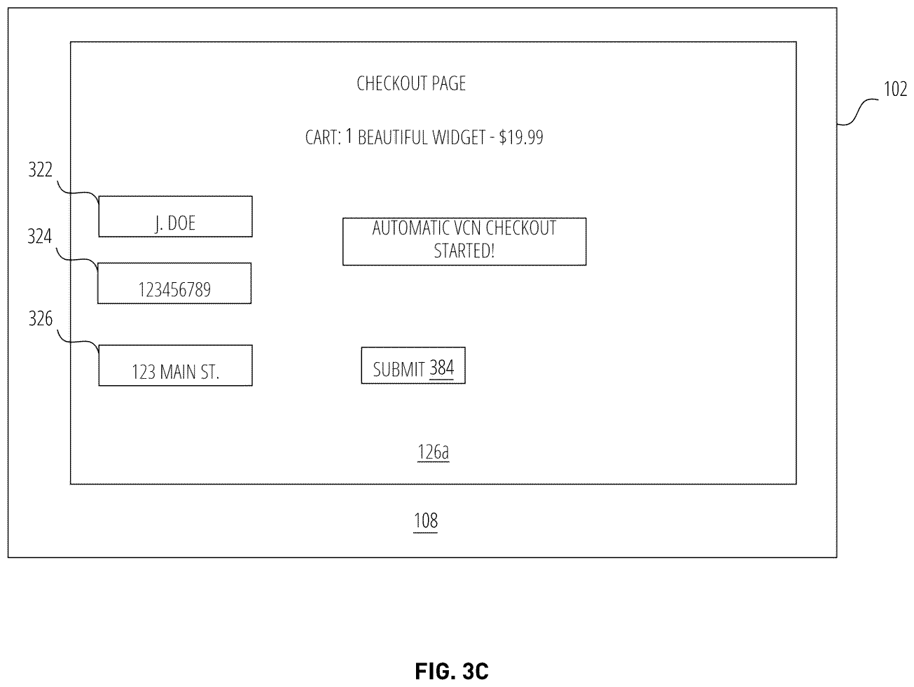

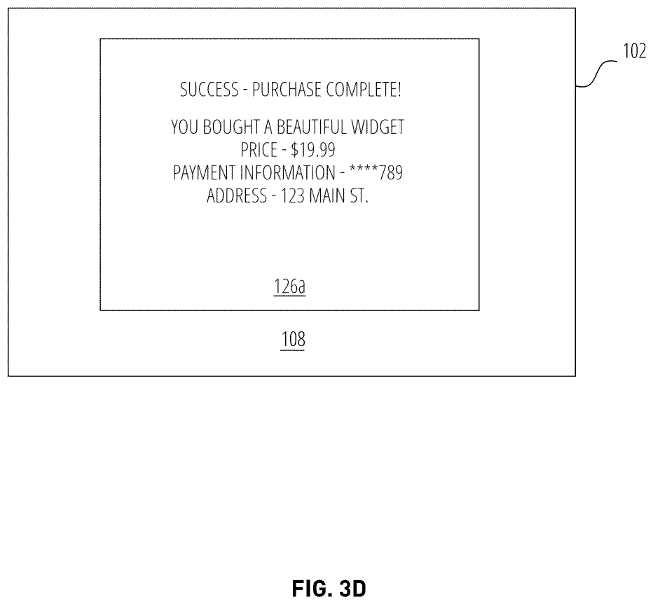

FIG. 3A illustrates an embodiment of an automated checkout on a client device 102, according to an embodiment. As shown, an application 108 such as a web browser has accessed a web page 126a, which is a checkout page on a merchant server 122. As shown, the checkout page 126a includes a plurality of form fields, including fields 322, 324, and 326. The AI assistant 128b may analyze the page 126a to determine the page is a checkout page. The AI assistant 128b may analyze data associated with the customer, e.g., the customer's transaction data 114, browsing data, customer data 116a, etc. The AI assistant 128b may determine, based on the analyses, a triggering event to present an automated checkout option.

Further, FIG. 3A illustrates how automated checkout functionalities might operate on a client device (102), focusing on a slightly different stage of the online shopping process. In this scenario, the user, employing an application (108) like a web browser, has already navigated beyond a product page and has accessed a specific web page (126a) identified as the checkout page. This page originates from the merchant's infrastructure (merchant server 122) and represents the critical point where final purchase details are typically entered. As is characteristic of such pages, FIG. 3A shows that page 126a includes numerous form fields requiring user input, with fields labeled 322, 324, and 326 serving as specific examples. These fields commonly correspond to sections for shipping address, billing information, contact details, and payment method entry.

Operating within this context, the AI assistant (128b) performs a detailed analysis of the loaded page 126a. The AI assistant 128b identifies the page's specific function-confirming it is indeed a checkout page. This involves parsing the page's structure, looking for characteristic elements such as groups of input fields labeled “Shipping Address,” “Payment Details,” or “Credit Card Number,” specific field names (like name=“address_line1”, name=“cc-number”), the presence of order summary sections, and buttons labeled “Place Order” or “Complete Purchase.” The URL structure might also be analyzed for common checkout path indicators.

The AI assistant 128b accesses and analyzes various data points associated with the customer. The AI assistant 128b evaluates the customer's historical transaction data (114) for patterns, recent Browse data for context on the current shopping session, and, crucially, customer data (116a). This customer data could contain securely stored information highly relevant to the checkout process, such as saved shipping addresses, billing addresses, and tokenized or saved payment methods, ideally kept up-to-date for accuracy.

Based on the combined insights from understanding the page structure (confirming it's a checkout page with specific fields 322, 324, 326, etc.) and analyzing the available, potentially current, customer data (116a, 114, etc.), the AI assistant (128b) determines if a predefined triggering event has occurred. In this checkout page scenario, a trigger might be the simple loading of the page itself, especially if the AI recognizes it possesses all necessary data to complete the form. Alternatively, triggers could include the user clicking into the first form field (e.g., 322) or pausing activity, suggesting potential benefit from assistance. Upon detecting such a trigger, the AI assistant would then present an automated checkout option, which, in the context of FIG. 3A, would likely be an offer to automatically and securely populate the various form fields (322, 324, 326, and others) using the customer's stored information, thereby significantly streamlining the final steps of the transaction.

FIG. 3B illustrates an embodiment where the AI assistant 128b presents an AI interface 354 on the client device 102. The AI interface 354 may be any selectable element, such as a graphic, button, link, popup, notification, etc. Once the user selects AI interface 354, the AI assistant 128b may automatically complete the checkout to purchase the widget, including filling the fields 322-326 with corresponding data elements. For example, AI assistant 128b may request generation of a VCN from the virtual card service 130, where the request may include one or more controls for the VCN. The AI assistant 128b may further access other information required to complete the purchase, e.g., customer name, address, email, etc., from the user's profile in the customer data 116a.

Moreover, following the determination of a triggering event on the checkout page (as described in the context of FIG. 3A), FIG. 3B illustrates the AI assistant (128b) taking proactive steps on the client device (102). Specifically, the AI assistant 128b presents a distinct AI interface element (354) directly within the user's view, e.g., overlaid or injected onto the merchant's checkout page (126a). This interface (354) serves as the explicit prompt for automated checkout assistance and can manifest in various user-friendly forms, such as a clickable button labeled “Complete Purchase Securely,” a noticeable graphic icon, a simple text link, a small pop-up window, or even a temporary notification banner.

In embodiments, automation proceeds once the user actively selects this presented AI interface (354). This selection acts as explicit user consent and instruction for the AI assistant (128b) to take over the completion of the checkout process. Upon receiving this confirmation, the AI assistant 128b initiates a sequence of automated actions designed to finalize the purchase of the widget. In one example, this may involve programmatically filling out the various form fields (previously identified, e.g., 322-326) on the merchant's checkout page.

To accomplish this, the AI assistant (128b) accesses the necessary personal information required by the form fields. It retrieves data such as the customer's name, shipping address, billing address, email address, and potentially phone number directly from the user's secure profile, stored within the customer data repository (116a), for example. For payment information, rather than using stored real card numbers directly in the form, the AI assistant 128b often employs enhanced security measures. As shown in this embodiment, it may communicate with a dedicated virtual card service (130) to request the generation of a Virtual Card Number (VCN). This request can include specific controls for the VCN, such as locking it to the current merchant, setting a spending limit equal to the transaction total, and defining it for single use or immediate expiry post-transaction. Once the virtual card service (130) provides the temporary VCN details, the AI assistant 128b securely inputs this information into the corresponding payment fields (e.g., 326) on the checkout form. By orchestrating these steps—retrieving user info, generating and inputting a secure VCN, and filling all required fields (322-326)—the AI assistant 128b fulfills the user's request to automatically and securely complete the purchase after the interface (354) was selected.

FIG. 3C illustrates an embodiment where the AI assistant 128b autofills the VCN information received from the virtual card service 130 into the form fields. As shown, field 322 includes the customer's name, field 324 includes the VCN generated by the virtual card service 130, and field 326 includes the customer's address. Other form fields not depicted may be filled by the AI assistant 128b, e.g., email, phone number, etc. Embodiments are not limited in these contexts. The AI assistant 128b may further select the submit 384 or generate code to cause the form to be submitted to the merchant server 122. The merchant server 122 may then process payment for the purchase using the VCN.

FIG. 3C illustrates an example of the checkout process following the AI assistant's (128b) automated actions initiated in FIG. 3B. This embodiment specifically visualizes the result of the AI assistant auto-filling the checkout form fields using the information obtained from both the user's profile (116a) and the virtual card service (130). As shown in this particular representation, the previously potentially empty form fields are now populated. Field 322, for instance, now displays the customer's name, retrieved from their profile data. Field 324 contains the Virtual Card Number (VCN) that was generated by the virtual card service (130) specifically for this transaction, ensuring the user's actual card number remains secure. Field 326 shows the customer's address, also sourced from their profile (116a)—reflecting the verified address information.

It's important to recognize that typical checkout forms contain more fields than just these three examples. The AI assistant (128b) would similarly populate other required fields not explicitly depicted in this diagram, such as the VCN's expiration date and CVV (also provided by the virtual card service 130), along with the customer's email address and phone number (retrieved from the customer data 116a).

Once all necessary fields on the checkout form are programmatically filled, the AI assistant (128b) proceeds to finalize the transaction by submitting the completed form to the merchant server (122). FIG. 3C indicates this can be achieved in one of two ways according to different embodiments: The AI assistant 128b may simulate a user action by programmatically selecting (clicking) the submit button, labeled here as 384, on the webpage. Alternatively, the AI assistant could generate and execute code (like JavaScript) within the browser environment that directly packages and transmits the form data to the merchant server (122), effectively achieving submission without needing to interact with the button element itself. Upon receiving the submitted data, the merchant server (122) initiates its standard payment processing workflow, using the provided VCN details to authorize and complete the purchase.

FIG. 3D illustrates an embodiment where the page 126a displays a confirmation for the automated purchase. As shown, the confirmation indicates the price paid, obfuscated VCN, and shipping address.

Moreover, FIG. 3D provides a visual example of a user interface element, specifically page 126a, designed to confirm the successful completion of an automated purchase process. This screen serves as a crucial feedback mechanism for the user, assuring them that the transaction initiated automatically has been finalized. The illustration highlights key pieces of information presented in such a confirmation. Notably, it includes the final price paid for the goods or services, allowing the user to verify the charged amount against their expectations or budget.

Furthermore, the confirmation displays an obfuscated VCN (Virtual Card Number).

This detail confirms the payment method used without compromising security. By showing only a portion of the VCN (e.g., the last four digits), the system verifies which virtual card facilitated the transaction while protecting the full sensitive card number from exposure. Additionally, the shipping address is shown, providing the user with an immediate opportunity to verify that the purchased item is being sent to the correct location, which is particularly important for physical goods acquired through automated means like subscriptions or one-click purchasing.

Other versions or embodiments of this confirmation screen might include additional details, such as an order number, estimated delivery date, a summary of the items purchased, or merchant information. Conversely, some embodiments might present less information depending on the specific requirements of the automated purchasing system or user preferences. The core function remains consistent: to provide clear confirmation of the automated transaction's details to the user.

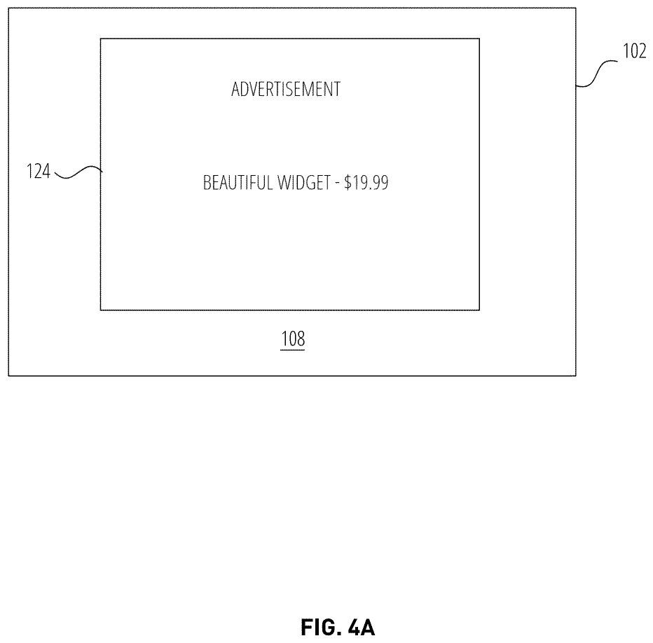

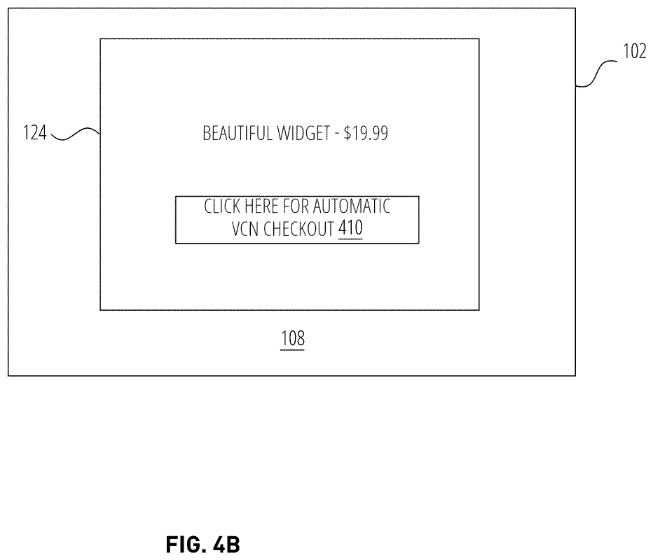

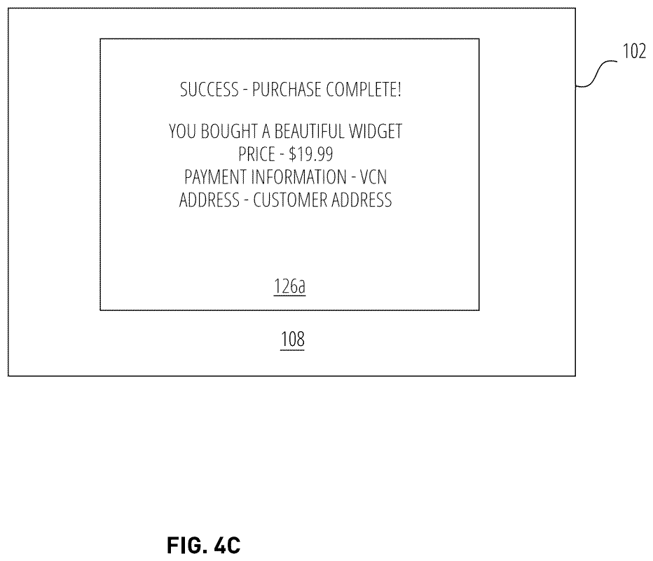

FIG. 4A illustrates an embodiment of an automated checkout on a client device 102, according to an embodiment. As shown, an application 108 such as a web browser has accessed content, such as a web page 126a, that includes an advertisement 124 for a widget. The AI assistant 128b may analyze the advertisement 124 to determine the advertisement 124 is associated with a product (e.g., based on a link the advertisement 124 is directed to, image analysis, reverse image search, etc.). The AI assistant 128b may analyze data associated with the customer, e.g., the customer's transaction data 114, browsing data, customer data 116a, etc. The AI assistant 128b may determine, based on the analyses, a triggering event to present an automated checkout option associated with the advertisement 124.

Moreover and in some instances, FIG. 4A illustrates the initial phase of an intelligent, automated checkout system operating within the familiar context of a user's interaction with their client device (102). As shown, the user is engaged in activity, such as browsing the web using an application (108) like a web browser. This application is currently displaying content, represented as web page 126a, which, in this example, contains an advertisement (124) promoting a specific item, referred to here as a “widget.”

In embodiments, the AI assistant (128b) operates proactively in the background. This AI assistant 128b actively monitors the content being displayed, specifically identifying the presence of the advertisement (124). The AI assistant 128b performs processing to understand the nature of this advertisement-confirming that it relates to a purchasable product. System 100 may employ various sophisticated techniques for this, such as analyzing the destination URL linked by the advertisement, performing image analysis on the ad's creative content, or even conducting a reverse image search to identify the product shown. This ensures the AI assistant 128b knows precisely what item is being offered.

Concurrently or subsequently, the AI assistant (128b) processes data associated specifically with the customer using the device. This involves analyzing information, which may include the customer's historical transaction data (114) to understand past purchasing behavior, their recent browse data to gauge current interests, and other stored customer profile information (116a), potentially encompassing preferences or demographics. By cross-referencing the identified product from the advertisement (124) with this personalized customer data, the AI assistant 128b performs a predictive analysis. If the analysis indicates a strong likelihood of purchase intent (e.g., the user recently searched for similar widgets, frequently buys from this brand, or the item aligns with their known preferences), the AI assistant 128b identifies this situation as a “triggering event.” Upon detecting such an event, the AI assistant 128b is designed to proactively present the user with an option to initiate an automated checkout process directly associated with the advertisement (124) they are currently viewing, thereby offering a potentially seamless path from ad discovery to purchase completion.

FIG. 4B illustrates an embodiment where the AI assistant 128b presents an AI interface 410 on the client device 102. The AI interface 410 may be any selectable element, such as a graphic, button, link, popup, notification, etc. Once the user selects AI interface 410, the AI assistant 128b may automatically complete a purchase for the widget. For example, the AI assistant 128b may navigate to the link associated with the advertisement (e.g., a product page 126a for the widget). The AI assistant 128b may then add the widget to the user's cart (using a selectable element of the web page 126a or by generating code to cause the widget to be added to the card). The AI assistant 128b may then optionally navigate to a predetermined checkout page 126a associated with the current merchant server 122. The AI assistant 128b may then request generation of a VCN from the virtual card service 130, where the request may include one or more controls for the VCN. The AI assistant 128b may further access other information required to complete the purchase, e.g., customer name, address, email, etc., from the customer's profile in the customer data 116a. Once received, the AI assistant 128b may provide the VCN and other data to the merchant server 122 to complete the transaction. In some embodiments, the AI assistant 128b uses interfaces (e.g., form fields such as fields 322-326, etc.) provided by the checkout page to complete the purchase. In some embodiments, the AI assistant 128b communicates directly with the merchant server 122 to complete the purchase without filling in the form fields, clicking submit, etc. The merchant server 122 may then process payment for the purchase using the VCN.

Further, following the triggering event described in FIG. 4A, FIG. 4B illustrates the subsequent phase where the AI assistant (128b) actively facilitates the automated purchase upon user confirmation. The process begins with the AI assistant 128b presenting a specific AI interface (410) directly on the user's client device (102). This interface acts as the user's explicit command prompt to initiate the automated transaction. It can take various forms depending on the application's design, appearing as a selectable button, a simple graphic, a hyperlink, a pop-up window, or even a system notification, ensuring flexibility in how the option is presented within the user's current context (like the web page 126a).

Once the user interacts with and selects this AI interface (410), signifying their intent to proceed, the AI assistant (128b) takes over the checkout process automatically. It executes a series of steps designed to mimic and streamline a manual purchase. For instance, the AI assistant might first navigate the application (e.g., the web browser) to the specific web page (126a) linked by the original advertisement (124), which is typically the product's detail page. From there, AI assistant 128b programmatically adds the targeted item (“widget”) to the online shopping cart. This action might involve identifying and interacting with standard web page elements like an “Add to Cart” button, or it could involve executing underlying code or scripts to achieve the same result more directly.

After securing the item in the cart, the AI assistant (128b) often navigates to the designated checkout page (126a) hosted by the relevant merchant server (122). The AI assistant 128b orchestrates the payment and information submission. The AI assistant 128b requests a secure Virtual Card Number (VCN) from a specialized virtual card service (130). This request can include parameters to define specific controls for the VCN, such as setting spending limits or restricting its use to the current merchant, enhancing security. The AI assistant 128b retrieves other necessary personal information-like the customer's name, shipping address, and email address—from the securely stored customer data profile (116a). The AI assistant 128b submits this complete package to the merchant server (122).

In some embodiments, the AI assistant 128b interacts with the merchant's checkout page similar to a human user, programmatically filling in the various form fields before triggering the submission. In other instances, the AI assistant 128b can bypass the visual form fields entirely, communicating the necessary VCN and customer data directly with the merchant server's (122) backend systems (e.g., via an API). This direct communication can be faster and less prone to errors caused by website layout changes. Regardless of the submission method, the final step involves the merchant server (122) receiving the payment details and processing the transaction using the provided VCN, thereby completing the purchase initiated just moments before by the user's selection of the AI interface (410).

FIG. 4C illustrates an embodiment where the page 126a displays a confirmation for the automated purchase. As shown, the confirmation indicates the price paid and that a VCN was used. Embodiments are not limited in these contexts.

FIG. 4C depicts the concluding user-facing element in the automated checkout workflow initiated in FIG. 4A and executed in FIG. 4B. It illustrates an embodiment where the application interface, designated as page 126a, now presents a confirmation message to the user, signifying the successful completion of the automated purchase facilitated by the AI assistant (128b). This confirmation screen serves as immediate validation for the user, assuring them that the transaction they authorized by selecting the AI interface (410) has been processed correctly by the merchant server.

As explicitly shown in this particular embodiment, the confirmation provides essential transactional details. It clearly indicates the final price paid for the item (the “widget”), allowing the user to instantly verify the charged amount. Furthermore, the confirmation explicitly states that a VCN (Virtual Card Number) was utilized for the payment. Mentioning the use of a VCN confirms the payment method employed by the AI assistant during the automated process, implicitly highlighting the secure payment mechanism facilitated by the system without needing to display any sensitive card number digits.

Moreover, FIG. 4C represents just one possible implementation. Other embodiments could present varying levels of detail. For example, alternative confirmation screens might include an obfuscated version of the VCN (showing perhaps the last four digits), the shipping address for physical goods, a summary of the purchased item(s), an order or confirmation number provided by the merchant, or an estimated delivery timeframe. The specific information displayed can be tailored based on the system's design choices, the nature of the purchase, and potentially user-defined preferences while still fulfilling the core purpose of confirming the automated transaction's success.

Operations for the disclosed embodiments are further described with reference to the following figures. Some of the figures include a logic flow. Although such figures presented herein include a particular logic flow, the logic flow merely provides an example of how the general functionality as described herein is implemented. Further, a given logic flow does not necessarily have to be executed in the order presented unless otherwise indicated. Moreover, not all acts illustrated in a logic flow are required in some embodiments. In addition, the given logic flow is implemented by a hardware element, a software element executed by one or more processing devices, or any combination thereof. The embodiments are not limited in this context.

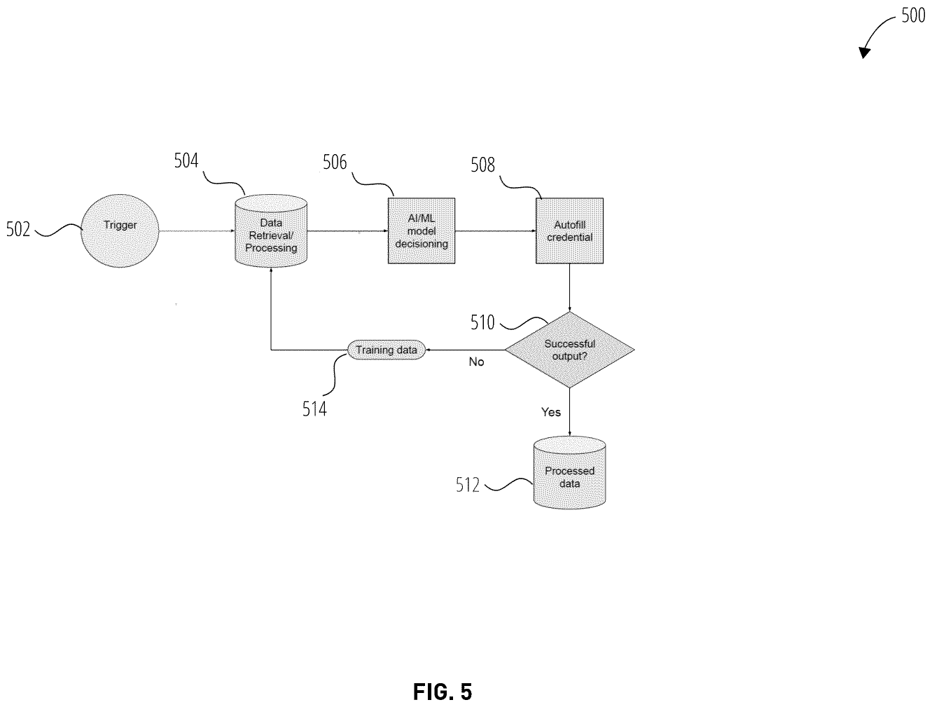

FIG. 5 illustrates an example flow 500. The flow 500 comprises an example implementation for using the AI assistants 128a-128c to perform automated checkouts. Although discussed with reference to AI assistant 128b, the flow 500 is equally applicable to all instances of the AI assistants 128a-128c.

At block 502, the AI assistant 128b may detect a trigger. As stated, the trigger may be any type of trigger, such as a customer using an application 108 to view a product page 126a on a merchant server 122, a customer accessing a checkout page 126a on a merchant server 122, a customer viewing an advertisement 124, etc. At block 504 the AI assistant 128b may perform data retrieval and processing. For example, the AI assistant 128b may access data from the data sources 112, the customer data 116a, and the merchant servers 122. Examples of data accessed at block 504 include customer purchase history, customer browsing history, browsing history for a plurality of users of the merchant servers 122, or any other type of data provided by the data sources 112, merchant servers 122, and/or financial institution servers 110.

At block 506, the AI assistant 128b may perform decisioning, e.g., to determine to perform an automated checkout. For example, the AI assistant 128b may determine to present a selectable option to process the automated checkout and present the selectable option to the customer via client device 102. Once selected, the AI assistant 128b may request a VCN from the virtual card service 130. In some embodiments, the request includes one or more controls for the VCN. The AI assistant 128b may then receive the VCN from the virtual card service 130. At block 508, the AI assistant 128b may autofill the VCN, expiration date, and CVV into one or more form fields on a checkout page 126a. The AI assistant 128b may further autofill other data from the customer data 116a into the forms, such as names, addresses, emails, etc. The AI assistant 128b may then submit the form or otherwise provide the VCN and associated data to the merchant server 122 to complete the purchase.

At block 510, the AI assistant 128b determines whether the purchase was completed successfully. If the purchase is completed successfully, data describing the purchase is stored in a data store, such as the merchant server 122, the financial institution server 110, data sources 112, or any combination thereof. Returning to block 510, if the purchase is not successful, data describing the automated checkout flow is provided as training data at block 514 to retrain the AI assistant 128b. Embodiments are not limited in these contexts.

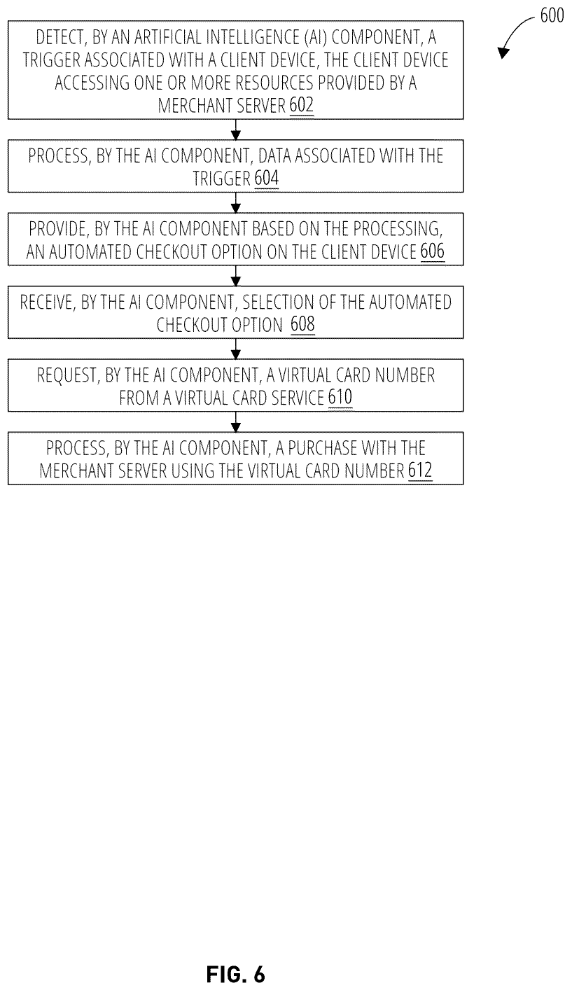

FIG. 6 illustrates an example flow 600. The flow 600 comprises an example implementation for using the AI assistants 128a-128c to perform automated checkouts. Although discussed with reference to AI assistant 128b, the flow 600 is equally applicable to all instances of the AI assistants 128a-128c.

In block 602, flow 600 detects, by an artificial intelligence (AI) component (e.g., one or more of AI assistants 128a-128c), a trigger associated with a client device 102, the client device 102 accessing one or more resources provided by a merchant server 122. In block 604, flow 600 processes, by the AI component, data associated with the trigger. In block 606, flow 600 provides, by the AI component based on the processing, an automated checkout option on the client device 102. In block 608, flow 600 receives, by the AI component, selection of the automated checkout option. In block 610, flow 600 requests, by the AI component, a virtual card number from a virtual card service 130. In block 612, flow 600 processes, by the AI component, a purchase with the merchant server 122 using the virtual card number.

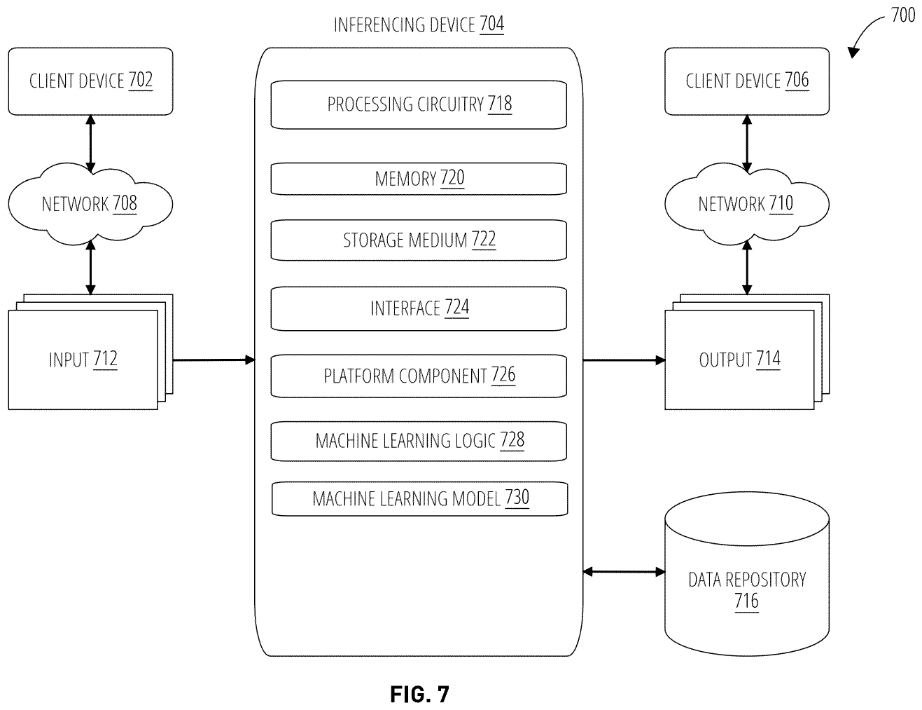

FIG. 7 illustrates an embodiment of a system 700. The system 700 is suitable for implementing one or more embodiments as described herein. In one embodiment, for example, the system 700 is an AI/ML system suitable for providing the AI assistants 128a-128c. Therefore, the system 700 is representative of the components of the system 100.

The system 700 comprises a set of M devices, where M is any positive integer. FIG. 7 depicts three devices (M=3), including a client device 702, an inferencing device 704, and a client device 706. The inferencing device 704 communicates information with the client device 702 and the client device 706 over a network 708 and a network 710, respectively. The information may include input 712 from the client device 702 and output 714 to the client device 706, or vice-versa. In one alternative, the input 712 and the output 714 are communicated between the same client device 702 or client device 706. In another alternative, the input 712 and the output 714 are stored in a data repository 716. In yet another alternative, the input 712 and the output 714 are communicated via a platform component 726 of the inferencing device 704, such as an input/output (I/O) device (e.g., a touchscreen, a microphone, a speaker, etc.). The client devices 102 are representative of the client device 702, client device 702, or the inferencing device 704.

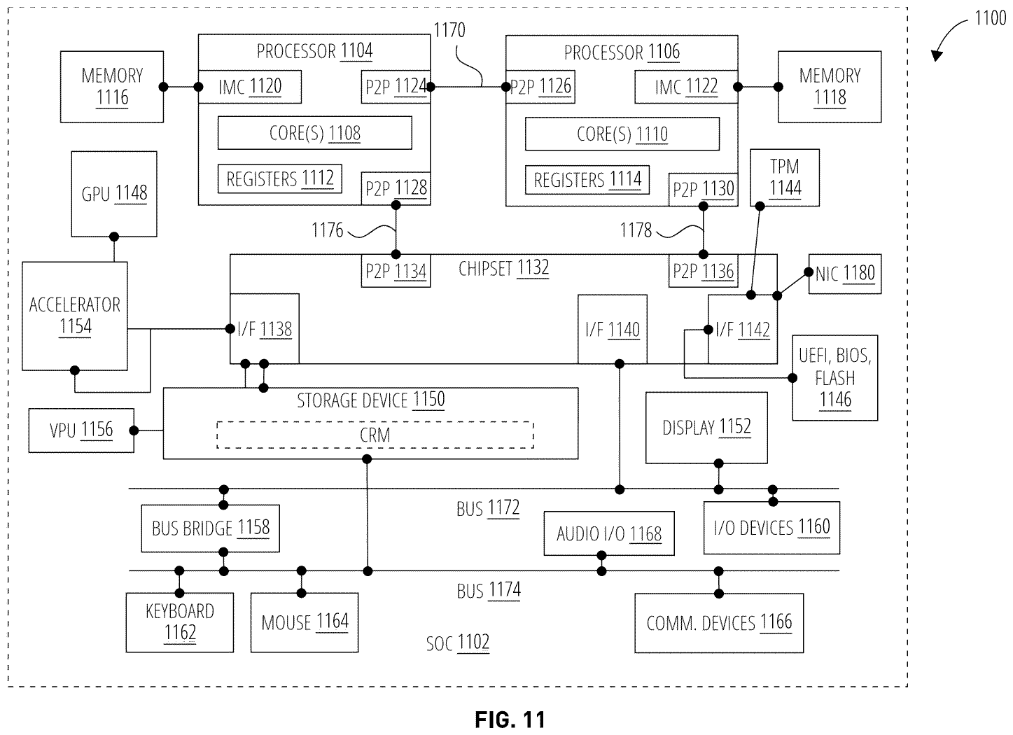

As depicted in FIG. 7, the inferencing device 704 includes processing circuitry 718, a memory 720, a storage medium 722, an interface 724, a platform component 726, ML logic 728, and an ML model 730. In some implementations, the inferencing device 704 includes other components or devices as well. Examples for software elements and hardware elements of the inferencing device 704 are described in more detail with reference to a computing architecture 1100 as depicted in FIG. 11. Embodiments are not limited to these examples.

The inferencing device 704 is generally arranged to receive an input 712, process the input 712 via one or more AI/ML techniques, and send an output 714. The inferencing device 704 receives the input 712 from the client device 702 via the network 708, the client device 706 via the network 710, the platform component 726 (e.g., a touchscreen as a text command or microphone as a voice command), the memory 720, the storage medium 722 or the data repository 716. The inferencing device 704 sends the output 714 to the client device 702 via the network 708, the client device 706 via the network 710, the platform component 726 (e.g., a touchscreen to present text, graphic or video information or speaker to reproduce audio information), the memory 720, the storage medium 722 or the data repository 716. Embodiments are not limited to these examples.

The inferencing device 704 includes ML logic 728 and an ML model 730 to implement various AI/ML techniques for various AI/ML tasks. The ML logic 728 receives the input 712, and processes the input 712 using the ML model 730. The ML model 730 performs inferencing operations to generate an inference for a specific task from the input 712. In some cases, the inference is part of the output 714. The output 714 is used by the client device 702, the inferencing device 704, or the client device 706 to perform subsequent actions in response to the output 714.

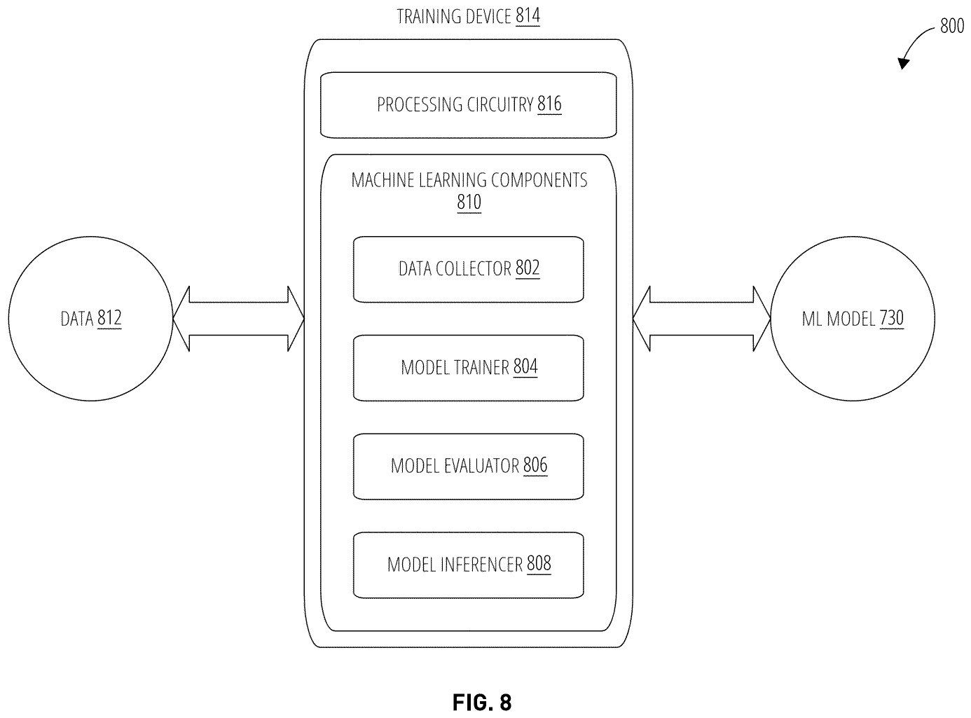

In various embodiments, the ML model 730 is a trained ML model 730 using a set of training operations. The ML model 730 is representative of the AI assistants 128a-128c. An example of training operations to train the ML model 730, including the AI assistants 128a-128c, is described with reference to FIG. 8.

FIG. 8 illustrates an apparatus 800. The apparatus 800 depicts a training device 814 suitable to generate a trained ML model 730 for the inferencing device 704 of the system 700. As depicted in FIG. 8, the training device 814 includes a processing circuitry 816 and a set of ML components 810 to support various AI/ML techniques, such as a data collector 802, a model trainer 804, a model evaluator 806 and a model inferencer 808. As stated, the ML model 730 is representative of the AI assistants 128a-128c.

In general, the data collector 802 collects data 812 from one or more data sources to use as training data for the ML model 730. The data collector 802 collects different types of data 812, such as text information, audio information, image information, video information, graphic information, and so forth. The data stored by the data sources 112, merchant servers 122, and financial institution servers 110 are examples of data 812 used to train the AI assistants 128a-128c as ML models 730. The model trainer 804 receives as input the collected data and uses a portion of the collected data as test data for an AI/ML algorithm to train the ML model 730. The model evaluator 806 evaluates and improves the trained ML model 730 using a portion of the collected data as test data to test the ML model 730. The model evaluator 806 also uses feedback information from the deployed ML model 730. The model inferencer 808 implements the trained ML model 730 to receive as input new unseen data, generate one or more inferences on the new data, and output a result such as an alert, a recommendation or other post-solution activity.

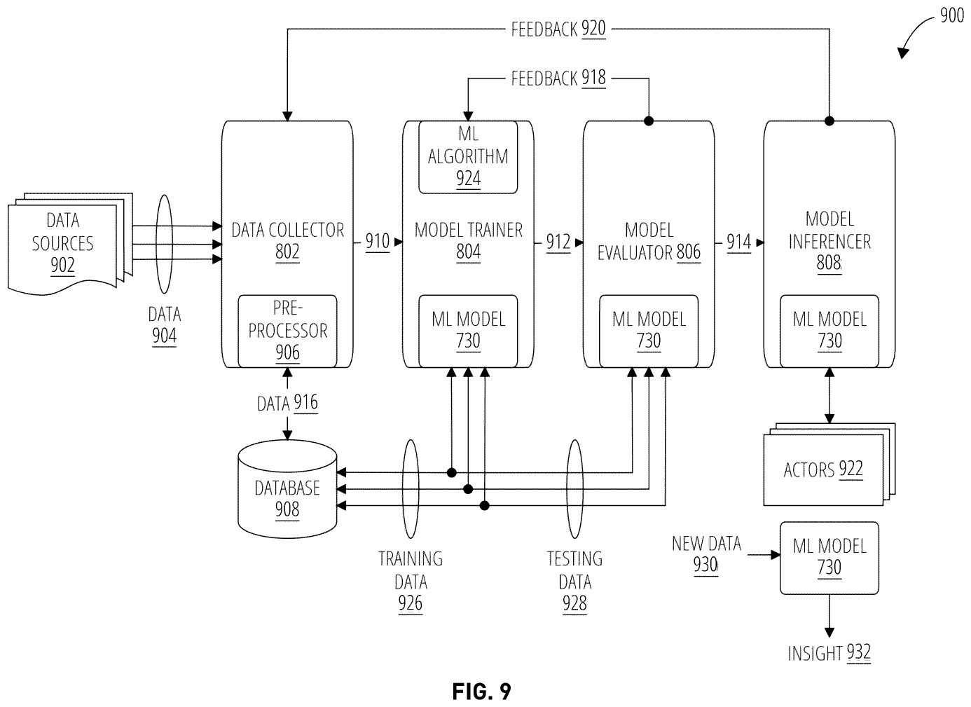

An exemplary AI/ML architecture for the ML components 810 is described in more detail with reference to FIG. 9.

FIG. 9 illustrates an artificial intelligence architecture 900 suitable for use by the training device 814 to generate the ML model 730 for deployment by the inferencing device 704. As stated, the AI assistants 128a-128c are examples of the ML model 730. Therefore, artificial intelligence architecture 900 is representative of an embodiment to train and generate the AI assistants 128a-128c. The artificial intelligence architecture 900 is an example of a system suitable for implementing various AI techniques and/or ML techniques to perform various inferencing tasks on behalf of the various devices of the system 700.

AI is a science and technology based on principles of cognitive science, computer science and other related disciplines, which deals with the creation of intelligent machines that work and react like humans. AI is used to develop systems that can perform tasks that require human intelligence such as recognizing speech, vision and making decisions. AI can be seen as the ability for a machine or computer to think and learn, rather than just following instructions. ML is a subset of AI that uses algorithms to enable machines to learn from existing data and generate insights or predictions from that data. ML algorithms are used to optimize machine performance in various tasks such as classifying, clustering and forecasting. ML algorithms are used to create ML models that can accurately predict outcomes.

In general, the artificial intelligence architecture 900 includes various machine or computer components (e.g., circuit, processor circuit, memory, network interfaces, compute platforms, input/output (I/O) devices, etc.) for an AI/ML system that are designed to work together to create a pipeline that can take in raw data, process it, train an ML model 730, evaluate performance of the trained ML model 730, and deploy the tested ML model 730 as the trained ML model 730 in a production environment, and continuously monitor and maintain it.

The ML model 730 is a mathematical construct used to predict outcomes based on a set of input data. The ML model 730 is trained using large volumes of training data 926, and it can recognize patterns and trends in the training data 926 to make accurate predictions. The ML model 730 is derived from an ML algorithm 924 (e.g., a neural network, decision tree, support vector machine, etc.). A data set is fed into the ML algorithm 924 which trains an ML model 730 to “learn” a function that produces mappings between a set of inputs and a set of outputs with a reasonably high accuracy. Given a sufficiently large enough set of inputs and outputs, the ML algorithm 924 finds the function for a given task. This function may even be able to produce the correct output for input that it has not seen during training. A data scientist prepares the mappings, selects and tunes the ML algorithm 924, and evaluates the resulting model performance. Once the ML logic 728 is sufficiently accurate on test data, it can be deployed for production use.

The ML algorithm 924 may comprise any ML algorithm suitable for a given AI task. Examples of ML algorithms may include supervised algorithms, unsupervised algorithms, or semi-supervised algorithms.

A supervised algorithm is a type of machine learning algorithm that uses labeled data to train a machine learning model. In supervised learning, the machine learning algorithm is given a set of input data and corresponding output data, which are used to train the model to make predictions or classifications. The input data is also known as the features, and the output data is known as the target or label. The goal of a supervised algorithm is to learn the relationship between the input features and the target labels, so that it can make accurate predictions or classifications for new, unseen data. Examples of supervised learning algorithms include: (1) linear regression which is a regression algorithm used to predict continuous numeric values, such as stock prices or temperature; (2) logistic regression which is a classification algorithm used to predict binary outcomes, such as whether a customer will purchase or not purchase a product; (3) decision tree which is a classification algorithm used to predict categorical outcomes by creating a decision tree based on the input features; or (4) random forest which is an ensemble algorithm that combines multiple decision trees to make more accurate predictions.

An unsupervised algorithm is a type of machine learning algorithm that is used to find patterns and relationships in a dataset without the need for labeled data. Unlike supervised learning, where the algorithm is provided with labeled training data and learns to make predictions based on that data, unsupervised learning works with unlabeled data and seeks to identify underlying structures or patterns. Unsupervised learning algorithms use a variety of techniques to discover patterns in the data, such as clustering, anomaly detection, and dimensionality reduction. Clustering algorithms group similar data points together, while anomaly detection algorithms identify unusual or unexpected data points. Dimensionality reduction algorithms are used to reduce the number of features in a dataset, making it easier to analyze and visualize. Unsupervised learning has many applications, such as in data mining, pattern recognition, and recommendation systems. It is particularly useful for tasks where labeled data is scarce or difficult to obtain, and where the goal is to gain insights and understanding from the data itself rather than to make predictions based on it.

Semi-supervised learning is a type of machine learning algorithm that combines both labeled and unlabeled data to improve the accuracy of predictions or classifications. In this approach, the algorithm is trained on a small amount of labeled data and a much larger amount of unlabeled data. The main idea behind semi-supervised learning is that labeled data is often scarce and expensive to obtain, whereas unlabeled data is abundant and easy to collect. By leveraging both types of data, semi-supervised learning can achieve higher accuracy and better generalization than either supervised or unsupervised learning alone. In semi-supervised learning, the algorithm first uses the labeled data to learn the underlying structure of the problem. It then uses this knowledge to identify patterns and relationships in the unlabeled data, and to make predictions or classifications based on these patterns. Semi-supervised learning has many applications, such as in speech recognition, natural language processing, and computer vision. It is particularly useful for tasks where labeled data is expensive or time-consuming to obtain, and where the goal is to improve the accuracy of predictions or classifications by leveraging large amounts of unlabeled data.

The ML algorithm 924 of the artificial intelligence architecture 900 is implemented using various types of ML algorithms including supervised algorithms, unsupervised algorithms, semi-supervised algorithms, or a combination thereof. A few examples of ML algorithms include support vector machine (SVM), random forests, naive Bayes, K-means clustering, neural networks, and so forth. A SVM is an algorithm that can be used for both classification and regression problems. It works by finding an optimal hyperplane that maximizes the margin between the two classes. Random forests is a type of decision tree algorithm that is used to make predictions based on a set of randomly selected features. Naive Bayes is a probabilistic classifier that makes predictions based on the probability of certain events occurring. K-Means Clustering is an unsupervised learning algorithm that groups data points into clusters. Neural networks is a type of machine learning algorithm that is designed to mimic the behavior of neurons in the human brain. Other examples of ML algorithms include a support vector machine (SVM) algorithm, a random forest algorithm, a naive Bayes algorithm, a K-means clustering algorithm, a neural network algorithm, an artificial neural network (ANN) algorithm, a convolutional neural network (CNN) algorithm, a recurrent neural network (RNN) algorithm, a long short-term memory (LSTM) algorithm, a deep learning algorithm, a decision tree learning algorithm, a regression analysis algorithm, a Bayesian network algorithm, a genetic algorithm, a federated learning algorithm, a distributed artificial intelligence algorithm, and so forth. Embodiments are not limited in this context.

As depicted in FIG. 9, the artificial intelligence architecture 900 includes a set of data sources 902 to source data 904 for the artificial intelligence architecture 900. Data sources 902 may comprise any device capable generating, processing, storing or managing data 904 suitable for a ML system. Examples of data sources 902 include without limitation the data sources 112, merchant servers 122, financial institution servers 110, databases, web scraping, sensors and Internet of Things (IoT) devices, image and video cameras, audio devices, text generators, publicly available databases, private databases, and many other data sources 902. The data sources 902 may be remote from the artificial intelligence architecture 900 and accessed via a network, local to the artificial intelligence architecture 900 an accessed via a network interface, or may be a combination of local and remote data sources 902. In some embodiments, the data sources 112, merchant servers 122, and/or financial institution servers 110 (including the customer data 116a) are representative of the data sources 902, and the data stored by the data sources 112, merchant servers 122, and financial institution servers 110 are representative of the data 904 to train the AI assistants 128a-128c as ML models 730.

The data sources 902 source difference types of data 904. By way of example and not limitation, the data 904 includes structured data from relational databases, such as customer profiles, transaction histories, or product inventories. The data 904 includes unstructured data from websites such as the websites themselves (e.g., pages 126a-126b), customer reviews, news articles, social media posts, or product specifications. The data 904 includes data from temperature sensors, motion detectors, and smart home appliances. The data 904 includes image data from medical images, security footage, or satellite images. The data 904 includes audio data from speech recognition, music recognition, or call centers. The data 904 includes text data from emails, chat logs, customer feedback, news articles or social media posts. The data 904 includes publicly available datasets such as those from government agencies, academic institutions, or research organizations. These are just a few examples of the many sources of data that can be used for ML systems. It is important to note that the quality and quantity of the data is critical for the success of a machine learning project.

The data 904 is typically in different formats such as structured, unstructured or semi-structured data. Structured data refers to data that is organized in a specific format or schema, such as tables or spreadsheets. Structured data has a well-defined set of rules that dictate how the data should be organized and represented, including the data types and relationships between data elements. Unstructured data refers to any data that does not have a predefined or organized format or schema. Unlike structured data, which is organized in a specific way, unstructured data can take various forms, such as text, images, audio, or video. Unstructured data can come from a variety of sources, including social media, emails, sensor data, and website content. Semi-structured data is a type of data that does not fit neatly into the traditional categories of structured and unstructured data. It has some structure but does not conform to the rigid structure of a traditional relational database. Semi-structured data is characterized by the presence of tags or metadata that provide some structure and context for the data.

The data sources 902 are communicatively coupled to a data collector 802. The data collector 802 gathers relevant data 904 from the data sources 902. Once collected, the data collector 802 may use a pre-processor 906 to make the data 904 suitable for analysis. This involves data cleaning, transformation, and feature engineering. Data preprocessing is a critical step in ML as it directly impacts the accuracy and effectiveness of the ML model 730. The pre-processor 906 receives the data 904 as input, processes the data 904, and outputs pre-processed data 916 for storage in a database 908. Examples for the database 908 includes a hard drive, solid state storage, and/or random access memory (RAM).

The data collector 802 is communicatively coupled to a model trainer 804. The model trainer 804 performs AI/ML model training, validation, and testing which may generate model performance metrics as part of the model testing procedure. The model trainer 804 receives the pre-processed data 916 as input 910 or via the database 908. The model trainer 804 implements a suitable ML algorithm 924 to train an ML model 730 on a set of training data 926 from the pre-processed data 916. The training process involves feeding the pre-processed data 916 into the ML algorithm 924 to produce or optimize an ML model 730 such as the AI assistants 128a-128c. The training process adjusts its parameters until it achieves an initial level of satisfactory performance.

The model trainer 804 is communicatively coupled to a model evaluator 806. After an ML model 730 is trained, the ML model 730 needs to be evaluated to assess its performance. This is done using various metrics such as accuracy, precision, recall, and F1 score. The model trainer 804 outputs the ML model 730, which is received as input 910 or from the database 908. The model evaluator 806 receives the ML model 730 as input 912, and it initiates an evaluation process to measure performance of the ML model 730. The evaluation process includes providing feedback 918 to the model trainer 804. The model trainer 804 re-trains the ML model 730 to improve performance in an iterative manner.

The model evaluator 806 is communicatively coupled to a model inferencer 808. The model inferencer 808 provides AI/ML model inference output (e.g., inferences, predictions or decisions). Once the ML model 730 is trained and evaluated, it is deployed in a production environment where it is used to make predictions on new data. The model inferencer 808 receives the evaluated ML model 730 as input 914. The model inferencer 808 uses the evaluated ML model 730 to produce insights or predictions on real data, which is deployed as a final production ML model 730. The inference output of the ML model 730 is use case specific. The model inferencer 808 also performs model monitoring and maintenance, which involves continuously monitoring performance of the ML model 730 in the production environment and making any necessary updates or modifications to maintain its accuracy and effectiveness. The model inferencer 808 provides feedback 918 to the data collector 802 to train or re-train the ML model 730. The feedback 918 includes model performance feedback information, which is used for monitoring and improving performance of the ML model 730.

Some or all of the model inferencer 808 is implemented by various actors 922 in the artificial intelligence architecture 900, including the ML model 730 of the inferencing device 704, for example. The actors 922 use the deployed ML model 730 on new data to make inferences or predictions for a given task, and output an insight 932. The actors 922 implement the model inferencer 808 locally, or remotely receives outputs from the model inferencer 808 in a distributed computing manner. The actors 922 trigger actions directed to other entities or to itself. The actors 922 provide feedback 920 to the data collector 802 via the model inferencer 808. The feedback 920 comprise data needed to derive training data, inference data or to monitor the performance of the ML model 730 and its impact to the network through updating of key performance indicators (KPIs) and performance counters.

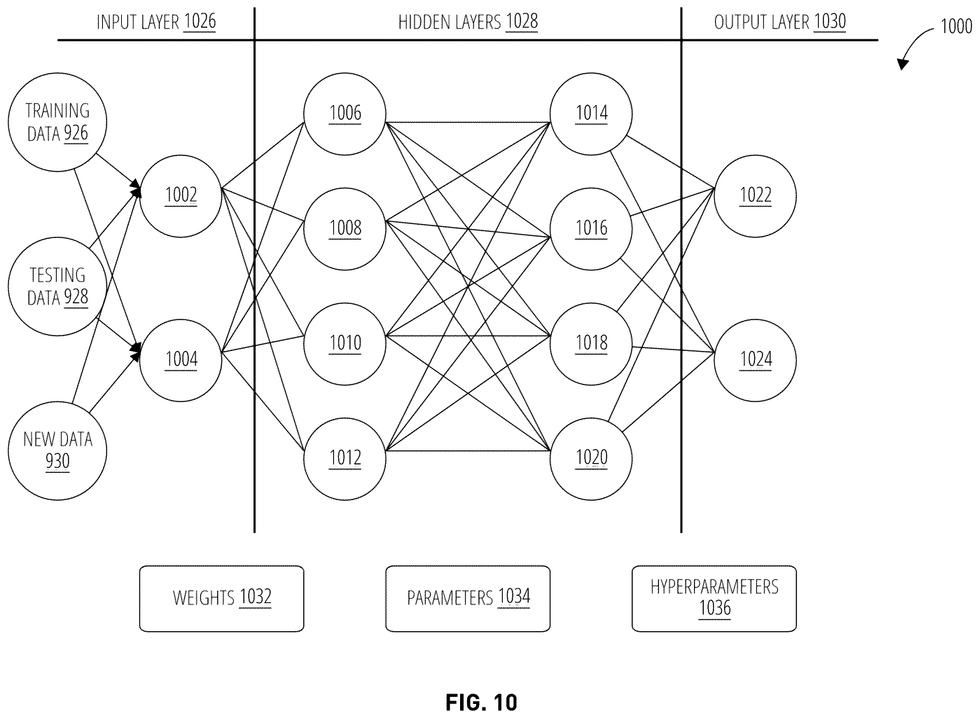

As previously described with reference to FIG. 6, FIG. 7, the systems 700, 800 implement some or all of the artificial intelligence architecture 900 to support various use cases and solutions for various AI/ML tasks. In various embodiments, the training device 814 of the apparatus 800 uses the artificial intelligence architecture 900 to generate and train the ML model 730 for use by the inferencing device 704 for the system 700. In various embodiments, the training device 814 uses the artificial intelligence architecture 900 to generate and train the AI assistants 128a-128c for use by the client device 102, merchant servers 122, and/or financial institution servers 110 of FIG. 1. In one embodiment, for example, the training device 814 may train the ML model 730 (e.g., the AI assistants 128a-128c) as a neural network, as described in more detail with reference to FIG. 10. Other use cases and solutions for AI/ML are possible as well, and embodiments are not limited in this context.

FIG. 10 illustrates an embodiment of an artificial neural network 1000. Neural networks, also known as artificial neural networks (ANNs) or simulated neural networks (SNNs), are a subset of machine learning and are at the core of deep learning algorithms. Their name and structure are inspired by the human brain, mimicking the way that biological neurons signal to one another. The artificial neural network 1000 is representative of the AI assistants 128a-128c.

Artificial neural network 1000 comprises multiple node layers, containing an input layer 1026, one or more hidden layers 1028, and an output layer 1030. Each layer comprises one or more nodes, such as nodes 1002 to 1024. As depicted in FIG. 10, for example, the input layer 1026 has nodes 1002, 1004. The artificial neural network 1000 has two hidden layers 1028, with a first hidden layer having nodes 1006, 1008, 1010 and 1012, and a second hidden layer having nodes 1014, 1016, 1018 and 1020. The artificial neural network 1000 has an output layer 1030 with nodes 1022, 1024. Each node 1002 to 1024 comprises a processing element (PE), or artificial neuron, that connects to another and has an associated weight and threshold. If the output of any individual node is above the specified threshold value, that node is activated, sending data to the next layer of the network. Otherwise, no data is passed along to the next layer of the network.

In general, artificial neural network 1000 relies on training data 926 (which may include data stored by the data sources 112, merchant servers 122, and/or financial institution servers 110) to learn and improve accuracy over time. However, once the artificial neural network 1000 is fine-tuned for accuracy, and tested on testing data 928, the artificial neural network 1000 is ready to classify and cluster new data 930 at a high velocity. Tasks in speech recognition or image recognition can take minutes versus hours when compared to the manual identification by human experts.

Each individual node 1002 to 1024 is a linear regression model, composed of input data, weights, a bias (or threshold), and an output. The linear regression model may have a formula similar to Equation (1), as follows:

$$\sum wixi + bias = w 1 x 1 + w 2 x 2 + w 3 x 3 + bias \qquad EQUATION ( 1 )$$

$$output = f ( x ) = 1 if \sum w 1 x 1 + b >= 0 ; 0 if \sum w 1 x 1 + b < 0$$

Once an input layer 1026 is determined, a set of weights 1032 are assigned. The weights 1032 help determine the importance of any given variable, with larger ones contributing more significantly to the output compared to other inputs. All inputs are then multiplied by their respective weights and then summed. Afterward, the output is passed through an activation function, which determines the output. If that output exceeds a given threshold, it “fires” (or activates) the node, passing data to the next layer in the network. This results in the output of one node becoming in the input of the next node. The process of passing data from one layer to the next layer defines the artificial neural network 1000 as a feedforward network.

In one embodiment, the artificial neural network 1000 leverages sigmoid neurons, which are distinguished by having values between 0 and 1. Since the artificial neural network 1000 behaves similarly to a decision tree, cascading data from one node to another, having x values between 0 and 1 will reduce the impact of any given change of a single variable on the output of any given node, and subsequently, the output of the artificial neural network 1000.

The artificial neural network 1000 has many practical use cases, like image recognition, speech recognition, text recognition or classification. The artificial neural network 1000 leverages supervised learning, or labeled datasets, to train the algorithm. As the model is trained, its accuracy is measured using a cost (or loss) function. This is also commonly referred to as the mean squared error (MSE). An example of a cost function is shown in Equation (2), as follows:

$$Cost Function = MSE = \frac{1}{2 m} {\sum }_{i = 1}^{m} {( \hat{{y}_{i}} - {y}_{i} )}^{2} \to MIN \qquad EQUATION ( 2 )$$

Where i represents the index of the sample, y-hat is the predicted outcome, y is the actual value, and m is the number of samples.

Ultimately, the goal is to minimize the cost function to ensure correctness of fit for any given observation. As the model adjusts its weights and bias, it uses the cost function and reinforcement learning to reach the point of convergence, or the local minimum. The process in which the algorithm adjusts its weights is through gradient descent, allowing the model to determine the direction to take to reduce errors (or minimize the cost function). With each training example, the parameters 1034 of the model adjust to gradually converge at the minimum.

In one embodiment, the artificial neural network 1000 is feedforward, meaning it flows in one direction only, from input to output. In one embodiment, the artificial neural network 1000 uses backpropagation. Backpropagation is when the artificial neural network 1000 moves in the opposite direction from output to input. Backpropagation allows calculation and attribution of errors associated with each neuron 1002 to 1024, thereby allowing adjustment to fit the parameters 1034 of the ML model 730 appropriately.

The artificial neural network 1000 is implemented as different neural networks depending on a given task. Neural networks are classified into different types, which are used for different purposes. In one embodiment, the artificial neural network 1000 is implemented as a feedforward neural network, or multi-layer perceptrons (MLPs), comprised of an input layer 1026, hidden layers 1028, and an output layer 1030. While these neural networks are also commonly referred to as MLPs, they are actually comprised of sigmoid neurons, not perceptrons, as most real-world problems are nonlinear. Trained data 904 usually is fed into these models to train them, and they are the foundation for computer vision, natural language processing, and other neural networks. In one embodiment, the artificial neural network 1000 is implemented as a convolutional neural network (CNN). A CNN is similar to feedforward networks, but usually utilized for image recognition, pattern recognition, and/or computer vision. These networks harness principles from linear algebra, particularly matrix multiplication, to identify patterns within an image. In one embodiment, the artificial neural network 1000 is implemented as a recurrent neural network (RNN). A RNN is identified by feedback loops. The RNN learning algorithms are primarily leveraged when using time-series data to make predictions about future outcomes, such as stock market predictions or sales forecasting. The artificial neural network 1000 is implemented as any type of neural network suitable for a given operational task of systems 100, 700, and the MLP, CNN, and RNN are merely a few examples. Embodiments are not limited in this context.

The artificial neural network 1000 includes a set of associated parameters 1034. There are a number of different parameters that must be decided upon when designing a neural network. Among these parameters are the number of layers, the number of neurons per layer, the number of training iterations, and so forth. Some of the more important parameters in terms of training and network capacity are a number of hidden neurons parameter, a learning rate parameter, a momentum parameter, a training type parameter, an Epoch parameter, a minimum error parameter, and so forth.

In some cases, the artificial neural network 1000 is implemented as a deep learning neural network. The term deep learning neural network refers to a depth of layers in a given neural network. A neural network that has more than three layers-which would be inclusive of the inputs and the output—can be considered a deep learning algorithm. A neural network that only has two or three layers, however, may be referred to as a basic neural network. A deep learning neural network may tune and optimize one or more hyperparameters 1036. A hyperparameter is a parameter whose values are set before starting the model training process. Deep learning models, including convolutional neural network (CNN) and recurrent neural network (RNN) models can have anywhere from a few hyperparameters to a few hundred hyperparameters. The values specified for these hyperparameters impacts the model learning rate and other regulations during the training process as well as final model performance. A deep learning neural network uses hyperparameter optimization algorithms to automatically optimize models. The algorithms used include Random Search, Tree-structured Parzen Estimator (TPE) and Bayesian optimization based on the Gaussian process. These algorithms are combined with a distributed training engine for quick parallel searching of the optimal hyperparameter values.

FIG. 11 illustrates an embodiment of a computing architecture 1100. Computing architecture 1100 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the computing architecture 1100 has a single processor with one core or more than one processor. Note that the term “processor” refers to a processor with a single core or a processor package with multiple processor cores. In at least one embodiment, the computing architecture 1100 is representative of the components of the system 700. More generally, the computing architecture 1100 is configured to implement all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary computing architecture 1100. For example, a component is, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server are a component. One or more components reside within a process and/or thread of execution, and a component is localized on one computer and/or distributed between two or more computers. Further, components are communicatively coupled to each other by various types of communications media to coordinate operations. The coordination involves the uni-directional or bi-directional exchange of information. For instance, the components communicate information in the form of signals communicated over the communications media. The information is implemented as signals allocated to various signal lines. In such allocations, each message is a signal. Further embodiments, however, alternatively employ data messages. Such data messages may be sent across various connections. Exemplary connections include parallel interfaces, serial interfaces, and bus interfaces.

As shown in FIG. 11, computing architecture 1100 comprises a system-on-chip (SoC) 1102 for mounting platform components. System-on-chip (SoC) 1102 is a point-to-point (P2P) interconnect platform that includes a first processor 1104 and a second processor 1106 coupled via a point-to-point interconnect 1170 such as an Ultra Path Interconnect (UPI). In other embodiments, the computing architecture 1100 is another bus architecture, such as a multi-drop bus. Furthermore, each of processor 1104 and processor 1106 are processor packages with multiple processor cores including core(s) 1108 and core(s) 1110, respectively. While the computing architecture 1100 is an example of a two-socket (2S) platform, other embodiments include more than two sockets or one socket. For example, some embodiments include a four-socket (4S) platform or an eight-socket (8S) platform. Each socket is a mount for a processor and may have a socket identifier. Note that the term platform refers to a motherboard with certain components mounted such as the processor 1104 and chipset 1132. Some platforms include additional components and some platforms include sockets to mount the processors and/or the chipset. Furthermore, some platforms do not have sockets (e.g. SoC, or the like). Although depicted as a SoC 1102, one or more of the components of the SoC 1102 are included in a single die package, a multi-chip module (MCM), a multi-die package, a chiplet, a bridge, and/or an interposer. Therefore, embodiments are not limited to a SoC.

The processor 1104 and processor 1106 are any commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures are also employed as the processor 1104 and/or processor 1106. Additionally, the processor 1104 need not be identical to processor 1106.

Processor 1104 includes an integrated memory controller (IMC) 1120 and point-to-point (P2P) interface 1124 and P2P interface 1128. Similarly, the processor 1106 includes an IMC 1122 as well as P2P interface 1126 and P2P interface 1130. IMC 1120 and IMC 1122 couple the processor 1104 and processor 1106, respectively, to respective memories (e.g., memory 1116 and memory 1118). Memory 1116 and memory 1118 are portions of the main memory (e.g., a dynamic random-access memory (DRAM)) for the platform such as double data rate type 4 (DDR4) or type 5 (DDR5) synchronous DRAM (SDRAM). In the present embodiment, the memory 1116 and the memory 1118 locally attach to the respective processors (i.e., processor 1104 and processor 1106). In other embodiments, the main memory couple with the processors via a bus and shared memory hub. Processor 1104 includes registers 1112 and processor 1106 includes registers 1114.

Computing architecture 1100 includes chipset 1132 coupled to processor 1104 and processor 1106. Furthermore, chipset 1132 are coupled to storage device 1150, for example, via an interface (I/F) 1138. The I/F 1138 may be, for example, a Peripheral Component Interconnect-enhanced (PCIe) interface, a Compute Express Link® (CXL) interface, or a Universal Chiplet Interconnect Express (UCIe) interface. Storage device 1150 stores instructions executable by circuitry of computing architecture 1100 (e.g., processor 1104, processor 1106, GPU 1148, accelerator 1154, vision processing unit 1156, or the like). For example, storage device 1150 can store instructions for the client device 702, the client device 706, the inferencing device 704, the training device 814, or the like.

Processor 1104 couples to the chipset 1132 via P2P interface 1128 and P2P 1134 while processor 1106 couples to the chipset 1132 via P2P interface 1130 and P2P 1136. Direct media interface (DMI) 1176 and DMI 1178 couple the P2P interface 1128 and the P2P 1134 and the P2P interface 1130 and P2P 1136, respectively. DMI 1176 and DMI 1178 is a high-speed interconnect that facilitates, e.g., eight Giga Transfers per second (GT/s) such as DMI 3.0. In other embodiments, the processor 1104 and processor 1106 interconnect via a bus.

The chipset 1132 comprises a controller hub such as a platform controller hub (PCH). The chipset 1132 includes a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 1132 comprises more than one controller hub such as a chipset with a memory controller hub, a graphics controller hub, and an input/output (I/O) controller hub.

In the depicted example, chipset 1132 couples with a trusted platform module (TPM) 1144 and UEFI, BIOS, FLASH circuitry 1146 via I/F 1142. The TPM 1144 is a dedicated microcontroller designed to secure hardware by integrating cryptographic keys into devices. The UEFI, BIOS, FLASH circuitry 1146 may provide pre-boot code. The I/F 1142 may also be coupled to a network interface circuit (NIC) 1180 for connections off-chip.

Furthermore, chipset 1132 includes the I/F 1138 to couple chipset 1132 with a high-performance graphics engine, such as, graphics processing circuitry or a graphics processing unit (GPU) 1148. In other embodiments, the computing architecture 1100 includes a flexible display interface (FDI) (not shown) between the processor 1104 and/or the processor 1106 and the chipset 1132. The FDI interconnects a graphics processor core in one or more of processor 1104 and/or processor 1106 with the chipset 1132.

The computing architecture 1100 is operable to communicate with wired and wireless devices or entities via the network interface (NIC) 1180 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE wireless technologies, among others. Thus, the communication is a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network is used to connect computers to each other, to the Internet, and to wired networks (which use IEEE 802.3-related media and functions).

Additionally, accelerator 1154 and/or vision processing unit 1156 are coupled to chipset 1132 via I/F 1138. The accelerator 1154 is representative of any type of accelerator device (e.g., a data streaming accelerator, cryptographic accelerator, cryptographic co-processor, an offload engine, etc.). One example of an accelerator 1154 is the Intel® Data Streaming Accelerator (DSA). The accelerator 1154 is a device including circuitry to accelerate copy operations, data encryption, hash value computation, data comparison operations (including comparison of data in memory 1116 and/or memory 1118), and/or data compression. Examples for the accelerator 1154 include a USB device, PCI device, PCIe device, CXL device, UCIe device, and/or an SPI device. The accelerator 1154 also includes circuitry arranged to execute machine learning (ML) related operations (e.g., training, inference, etc.) for ML models. Generally, the accelerator 1154 is specially designed to perform computationally intensive operations, such as hash value computations, comparison operations, cryptographic operations, and/or compression operations, in a manner that is more efficient than when performed by the processor 1104 or processor 1106. Because the load of the computing architecture 1100 includes hash value computations, comparison operations, cryptographic operations, and/or compression operations, the accelerator 1154 greatly increases performance of the computing architecture 1100 for these operations.

The accelerator 1154 includes one or more dedicated work queues and one or more shared work queues (each not pictured). Generally, a shared work queue is configured to store descriptors submitted by multiple software entities. The software is any type of executable code, such as a process, a thread, an application, a virtual machine, a container, a microservice, etc., that share the accelerator 1154. For example, the accelerator 1154 is shared according to the Single Root I/O virtualization (SR-IOV) architecture and/or the Scalable I/O virtualization (S-IOV) architecture. Embodiments are not limited in these contexts.

Various I/O devices 1160 and display 1152 couple to the bus 1172, along with a bus bridge 1158 which couples the bus 1172 to a second bus 1174 and an I/F 1140 that connects the bus 1172 with the chipset 1132. In one embodiment, the second bus 1174 is a low pin count (LPC) bus. Various input/output (I/O) devices couple to the second bus 1174 including, for example, a keyboard 1162, a mouse 1164 and communication devices 1166.

Furthermore, an audio I/O 1168 couples to second bus 1174. Many of the I/O devices 1160 and communication devices 1166 reside on the system-on-chip (SoC) 1102 while the keyboard 1162 and the mouse 1164 are add-on peripherals. In other embodiments, some or all the I/O devices 1160 and communication devices 1166 are add-on peripherals and do not reside on the system-on-chip (SoC) 1102.

The various elements of the devices as previously described with reference to the figures include various hardware elements, software elements, or a combination of both. Examples of hardware elements include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements varies in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment are implemented by representative instructions stored on a machine-readable medium which represents various logic within the processor, which when read by a machine causes the machine to fabricate logic to perform the techniques described herein. Such representations, known as “intellectual property (IP) cores” are stored on a tangible, machine readable medium and supplied to various customers or manufacturing facilities to load into the fabrication machines that make the logic or processor. Some embodiments are implemented, for example, using a machine-readable medium or article which may store an instruction or a set of instructions that, when executed by a machine, causes the machine to perform a method and/or operations in accordance with the embodiments. Such a machine includes, for example, any suitable processing platform, computing platform, computing device, processing device, computing system, processing system, processing devices, computer, processor, or the like, and is implemented using any suitable combination of hardware and/or software. The machine-readable medium or article includes, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions include any suitable type of code, such as source code, compiled code, interpreted code, executable code, static code, dynamic code, encrypted code, and the like, implemented using any suitable high-level, low-level, object-oriented, visual, compiled and/or interpreted programming language.

As utilized herein, terms “component,” “system,” “interface,” and the like are intended to refer to a computer-related entity, hardware, software (e.g., in execution), and/or firmware. For example, a component is a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server is also a component. One or more components reside within a process, and a component is localized on one computer and/or distributed between two or more computers. A set of elements or a set of other components are described herein, in which the term “set” can be interpreted as “one or more.”

Further, these components execute from various computer readable storage media having various data structures stored thereon such as with a module, for example. The components communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component is an apparatus with specific functionality provided by mechanical parts operated by electric or electronic circuitry, in which the electric or electronic circuitry is operated by a software application or a firmware application executed by one or more processors. The one or more processors are internal or external to the apparatus and execute at least a part of the software or firmware application. As yet another example, a component is an apparatus that provides specific functionality through electronic components without mechanical parts; the electronic components include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items may be distinct or they may be the same, although in some situations the context may indicate that they are distinct or that they are the same.

As used herein, the term “circuitry” may refer to, be part of, or include a circuit, an integrated circuit (IC), a monolithic IC, a discrete circuit, a hybrid integrated circuit (HIC), an Application Specific Integrated Circuit (ASIC), an electronic circuit, a logic circuit, a microcircuit, a hybrid circuit, a microchip, a chip, a chiplet, a chipset, a multi-chip module (MCM), a semiconductor die, a system on a chip (SoC), a processor (shared, dedicated, or group), a processor circuit, a processing circuit, or associated memory (shared, dedicated, or group) operably coupled to the circuitry that execute one or more software or firmware programs, a combinational logic circuit, or other suitable hardware components that provide the described functionality. In some embodiments, the circuitry is implemented in, or functions associated with the circuitry are implemented by, one or more software or firmware modules. In some embodiments, circuitry includes logic, at least partially operable in hardware. It is noted that hardware, firmware and/or software elements may be collectively or individually referred to herein as “logic” or “circuit.”

Some embodiments are described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately can be employed in combination with each other unless it is noted that the features are incompatible with each other.

Some embodiments are presented in terms of program procedures executed on a computer or network of computers. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments are described using the expression “coupled” and “connected” along with their derivatives. These terms are not necessarily intended as synonyms for each other. For example, some embodiments are described using the terms “connected” and/or “coupled” to indicate that two or more elements are in direct physical or electrical contact with each other. The term “coupled,” however, also means that two or more elements are not in direct contact with each other, but yet still co-operate or interact with each other.

Various embodiments also relate to apparatus or systems for performing these operations. This apparatus is specially constructed for the required purpose or it comprises a general purpose computer as selectively activated or reconfigured by a computer program stored in the computer. The procedures presented herein are not inherently related to a particular computer or other apparatus. Various general purpose machines are used with programs written in accordance with the teachings herein, or it proves convenient to construct more specialized apparatus to perform the required method steps. The required structure for a variety of these machines are apparent from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The following examples pertain to further embodiments, from which numerous permutations and configurations will be apparent.

What is claimed is:

1. A system for facilitating automated checkout, comprising:
a processor; and
memory communicatively coupled to the processor, the memory storing instructions executable by the processor to configure the system as an artificial intelligence (AI) component configured to:
process content presented on a communicatively coupled client device, wherein the content originates from a merchant server and identifies a specific purchasable item;
process user data associated with the client device or a user of the client device, the user data reflecting historical user behavior or preferences;
determine, based on analysis of the content and analysis of the user data, that a predefined trigger condition for offering automated checkout related to the specific purchasable item is met;
cause, responsive to determining the trigger condition is met, presentation of a selectable interface element representing an automated checkout option via the client device;
receive, via the client device, an indication signifying user selection of the selectable interface element;
request, via a virtual card service, a virtual card number designated for a transaction with the merchant server; and
initiate, with the merchant server, the transaction for the specific purchasable item with the merchant server by providing at least the requested virtual card number to the merchant server.

2. The system of claim 1, wherein the trigger comprises the client device interacting with a resource related to a product on the merchant server.

3. The system of claim 1, wherein the trigger is initiated upon the client device navigating to a link designated for starting a checkout process hosted by the merchant server.

4. The system of claim 2, wherein the trigger comprises the client device requesting and loading content from the merchant server corresponding to a page, wherein the loaded content includes data configured to display an advertisement.

5. The system of claim 2, wherein the AI component is implemented as executable code within a browser extension configured to operate on a client device.

6. A computer-implemented method, comprising:
detecting, by an artificial intelligence (AI) assistant associated with a user, a trigger event indicating a potential purchase transaction on a merchant server;
accessing, by the AI assistant responsive to the trigger event, data associated with the user and the potential purchase transaction from one or more data sources;
determining, by the AI assistant based at least in part on the accessed data, to initiate an automated checkout process for the potential purchase transaction;
requesting, by the AI assistant, a virtual card number (VCN) associated with the user from a virtual card service;
receiving, by the AI assistant, the VCN and associated payment details from the virtual card service;
populating, automatically by the AI assistant, one or more fields of a checkout interface presented by the merchant server with at least the received VCN and associated payment details; and
submitting, by the AI assistant, the populated checkout interface to the merchant server to attempt completion of the purchase transaction.

7. The computer-implemented method of claim 6, wherein the trigger event comprises the user accessing a checkout page presented by the merchant server via a client device.

8. The computer-implemented method of claim 6, wherein accessing data further comprises accessing at least one of customer purchase history, customer Browse history from the one or more data sources, or both.

9. The computer-implemented method of claim 6, further comprising, prior to requesting the VCN:
presenting, by the AI assistant via a client device associated with the user, a selectable option to proceed with the automated checkout process; and
receiving, by the AI assistant, an indication that the user has selected the option.

10. The computer-implemented method of claim 8, wherein automatically populating further comprises automatically populating one or more fields of the checkout interface with user data comprising a user name, a user address, a user email address, or combination thereof, and wherein said user data is retrieved from the accessed data.

11. The computer-implemented method of claim 6, comprising:
determining, by the AI assistant, whether the attempted completion of the purchase transaction was successful or unsuccessful; and
responsive to determining that the attempt was unsuccessful, providing data describing the automated checkout process as training data for retraining the AI assistant.

12. A non-transitory computer-readable storage medium, the computer-readable storage medium including instructions that when executed by a computing device, cause the computing device to:
detect a trigger associated with a client device, the client device accessing one or more resources provided by a merchant server;
processing data associated with the trigger;
provide an automated checkout option on the client device;
receive selection of the automated checkout option;
request a virtual card number from a virtual card service; and
processing a purchase with the merchant server using the virtual card number.

13. The computer-readable storage medium of claim 12, wherein the trigger comprises the client device accessing a product page on the merchant server.

14. The computer-readable storage medium of claim 12, wherein the trigger comprises the client device accessing a checkout page on the merchant server.

15. The computer-readable storage medium of claim 12 including instructions that when executed by the computing device, cause the computing device to access via the client device a page on the merchant server that includes an advertisement.

16. The computer-readable storage medium of claim 12, wherein the instructions are implemented in a browser extension.

17. The computer-readable storage medium of claim 12 including instructions that when executed by the computing device, cause the computing device to autofill the virtual card number and data associated with a customer into one or more form fields.

18. A method for training an artificial intelligence (AI) assistant, comprising:
assembling a training dataset comprising user data associated with user activities, merchant data associated with merchant platforms, and contextual data associated with user environments;
providing the assembled training dataset to an AI model; and
training the AI model using the provided training dataset to generate a trained AI assistant configured to perform operations comprising one or more of:
identifying trigger conditions for initiating an automated checkout process based on analysis of user interaction data and merchant data,
identifying conditions for refraining from initiating the automated checkout process based on analysis of user data or contextual data,
selectively initiating an automated checkout process based at least in part on the identified trigger conditions and an absence of identified conditions for refraining, and
a combination thereof.

19. The method of claim 18, wherein:
the user data comprises user transaction history, user Browse history, user profile information, and user dialogue data;
the merchant data comprises merchant webpage structure, merchant application configuration, merchant server configuration, and merchant risk assessment data; and
the contextual data comprises advertisement interaction data, social media activity data, and loyalty program data.

20. The method of claim 18, wherein the trained AI assistant is further configured such that the selectively initiated automated checkout process utilizes a virtual card number (VCN) obtained from a virtual card service.
